(19) United States
(12) Patent Application Publication
(10) Pub. No.: US 2026/0164520 A1
(43) Pub. Date: Jun. 11, 2026

(54) CONTROL UNITS AND CONTROL CIRCUITS FOR LIGHTING DEVICE, AND THE LIGHTING DEVICES

(71) Applicant: SAVANT TECHNOLOGIES LLC, East Cleveland, OH (US)

(72) Inventors: Shengyou SUN, Shanghai (CN); Kun XIAO, Shanghai (CN)

(73) Assignee: SAVANT TECHNOLOGIES LLC, East Cleveland, OH (US)

(21) Appl. No.: 19/379,954

(22) Filed: Nov. 5, 2025

(30) Foreign Application Priority Data
Nov. 13, 2024 (CN) 2024116207566

(51) Int. Cl. H05B 45/20; H05B 45/345; H05B 45/36; H05B 47/155

(52) U.S. Cl. CPC H05B 45/20; H05B 45/345; H05B 45/36; H05B 47/155

(57) ABSTRACT

Provided are control units and control circuits for lighting devices, and the lighting devices. Color temperatures of lamp loads of a lighting device are different from each other, a first end of each lamp load is connected to a power input end, and the control unit is connected to a drive circuit that includes a constant-current chip having a voltage detection terminal, a current detection terminal and a current input terminal grounded and connected to the current input terminal, the control unit includes resistors where the resistance values of two resistors being different, and a first end of each resistor being connected to the voltage detection terminal, and a selector switch, which is operable to connect the current input terminal to a second end of one lamp load and a second end of any resistor.

### CROSS-REFERENCE TO RELATED APPLICATIONS

This application claims priority to Chinese Patent Application Serial Number 2024116207566, filed Nov. 13, 2024, which is herein incorporated by reference.

### TECHNICAL FIELD

The present application relates to control units for lighting devices, and more particularly, to control units for adjusting power and color temperature of lighting devices, control circuits comprising the control units, and lighting devices comprising the control circuits.

### BACKGROUND

For lighting devices, especially LED lighting devices using a constant-current driver chip, generally, the color temperature and power thereof need to be adjusted, to meet different lighting requirements. Currently, such devices typically rely on two independent switches to respectively control color temperature and power. This increases the complexity of a mechanical structure of the lighting device and raw material costs of the device. In addition, providing two switches on the outer surface of the lighting device is cumbersome, and also affects the overall appearance of the device.

In view of this, it is desirable to provide an improved method for adjusting both color temperature and power of the lighting device, which can simplify the structure of the lighting device, reduce device costs, while achieving a more concise device appearance.

### SUMMARY OF THE INVENTION

The present application is proposed in view of the described problems, a main object of the present application is to provide control units for achieving, by a single switch, dual adjustment of color temperature and power of lighting devices using a constant-current driver chip, control circuits comprising the control units, and lighting devices comprising the control circuits, so as to solve the technical problem in the prior art that it is difficult to simply and conveniently adjust both color temperature and power of a lighting device using a constant-current driver chip.

In order to achieve the described object, according to one aspect of the present application, provided is a control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is grounded via a grounding resistor inside the constant-current driver chip; and the control unit comprises: a plurality of switching resistors, wherein each of the switching resistors comprises a first end and a second end, the first end of each of the switching resistors is connected to the voltage detection terminal, and resistance values of at least two switching resistors of the plurality of switching resistors are different from each other; and a selector switch, which is operable to connect the current input terminal to the second end of at least one lamp load of the plurality of lamp loads, while connecting the current input terminal to the second end of any one switching resistor of the plurality of switching resistors; wherein the constant-current driver chip is configured to compare a detected first voltage at the current detection terminal with a threshold voltage to control a current flowing through the current input terminal, the threshold voltage being determined according to a detected second voltage at the voltage detection terminal.

In this way, by operating the single selector switch, the current input terminal can be switched to be connected to different lamp loads of the plurality of lamp loads or connected to at least two lamp loads via paths of different resistance values so as to adjust the color temperature of the lighting device, and also the current input terminal can be switched to be connected to different resistors of the plurality of switching resistors so as to adjust the power of the lighting device. Thus, a single selector switch is used to realize dual adjustment of color temperature and power, thereby simplifying the structural design of the lighting device, while reducing the cost of the lighting device.

Further, according to an embodiment of the present application, the plurality of switching resistors comprise a first switching resistor, the second end of the first switching resistor being connected to the current input terminal.

In this way, a resistor in parallel connection with the first switching resistor can be changed by operating the selector switch to change the voltage at the voltage detection terminal, thereby changing the threshold voltage for controlling the voltage at the current detection terminal, thereby changing the current of the lamp load, i.e. changing the power of the lighting device. Furthermore, in the case where the second end of the first switching resistor is connected to the current input terminal, since the current input terminal is also connected to a positive electrode (i.e. the first end) of the lamp load, it is possible to prevent the voltage detection terminal from being in a floating state.

Further, according to an embodiment of the present application, the selector switch comprises a manipulation portion, at least one first switching element and one second switching element, wherein each first switching element of the at least one first switching element comprises a first fixed connection end and a first movable connection end, and the second switching element comprises a second fixed connection end and a second movable connection end; the second fixed connection end and the at least one first fixed connection end of the at least one first switching element are connected to the current input terminal, and the second movable connection end and the at least one first movable connection end of the at least one first switching element are both mechanically connected to the manipulation portion.

In this way, a user can achieve connection switching of the at least one first movable connection end and the second movable connection end by operating the single manipulation portion, thereby achieving dual adjustment of the color temperature and power of the lighting device.

Further, according to an embodiment of the present application, the selector switch comprises one first switching element, and the selector switch is operable to connect the current input terminal to the second end of any one lamp load of the plurality of lamp loads, while connecting the current input terminal to the second end of any one switching resistor of the plurality of switching resistors; the selector switch further comprises a plurality of first stationary contacts and a plurality of second stationary contacts, the second end of each of the plurality of lamp loads is connected to at least one first stationary contact of the plurality of first stationary contacts via at least one independent first path, the second end of each of the plurality of switching resistors is connected to at least one second stationary contact of the plurality of second stationary contacts via at least one independent second path; and the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor.

In this way, by providing one first switching element and one second switching element, the color temperature of the lighting device can be switched by switching the lamp load to which the current input terminal is connected. In this case, each first stationary contact and a corresponding one second stationary contact form one gear, such that the user can implement gear-by-gear adjustment of the color temperature and the power by operating the single manipulation portion. Furthermore, in the case that the second end of each lamp load is connected to several first stationary contacts respectively, the power can be switched stage by stage while keeping the color temperature unchanged. In the case that the second end of each switching resistor is connected to several second stationary contacts respectively, the color temperature can be switched stage by stage while keeping the power unchanged.

Further, according to an embodiment of the present application, the first fixed connection end of the first switching element and the second fixed connection end of the second switching element are configured to be immovable, and the first movable connection end and the second movable connection end are configured to rotate together; and the plurality of first stationary contacts are arranged around the first fixed connection end at predetermined intervals, and the plurality of second stationary contacts are arranged around the second fixed connection end at the predetermined intervals, such that when the first movable connection end and the second movable connection end move together by the predetermined interval, the first movable connection end switches from being connected to one first stationary contact to being connected to another adjacent first stationary contact, and the second movable connection end switches from being connected to one second stationary contact to being connected to another adjacent second stationary contact.

In this way, by operating the single manipulation portion, the first movable connection end and the second movable connection end can be driven to move together, realizing connection switching between the first movable connection end and the second movable connection end, thereby achieving dual adjustment of the color temperature and power of the lighting device. In this case, the selector switch may be a double-pole multi-throw switch.

Further, according to an embodiment of the present application, the selector switch comprises at least two first switching elements, and the selector switch is operable to connect the current input terminal to the second ends of any two lamp loads of the plurality of lamp loads, while connecting the current input terminal to the second end of any one switching resistor of the plurality of switching resistors; the selector switch further comprises a plurality of first stationary contacts and a plurality of second stationary contacts, the second end of each of the at least two lamp loads is connected to at least two first stationary contacts of the plurality of first stationary contacts via at least two independent first paths, and resistance values of the at least two independent first paths are different from each other or partially different from each other; the second end of each of the plurality of switching resistors is connected to at least one second stationary contact of the plurality of second stationary contacts via at least one independent second path; and the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor.

In this way, by providing one second switching element and at least two first switching elements, the current input terminal can be simultaneously connected to at least two lamp loads via paths of different resistance values, such that the color temperature of the lighting device is adjusted by mixing currents flowing through the at least two lamp loads at different ratios. In this case, one second stationary contact and at least two first stationary contacts respectively corresponding to the second switching element and the at least two first switching elements may form one gear, such that the user may perform gear-by-gear adjustment of the color temperature and power by operating the single manipulation portion.

Further, according to an embodiment of the present application, the at least two first fixed connection ends of the at least two first switching elements and the second fixed connection end of the second switching element are configured to be immovable, and the second movable connection end and the at least two first movable connection ends are configured to rotate together; the at least two first stationary contacts to which the second end of each lamp load of the at least two lamp loads is connected are arranged around a corresponding first fixed connection end of the at least two first fixed connection ends at predetermined intervals, and the plurality of second stationary contacts are arranged around the second fixed connection end at the predetermined intervals, such that when the second movable connection end and the at least two first movable connection ends move together by the predetermined interval, each first movable connection end of the at least two first movable connection ends is switched from being connected to one first stationary contact of the corresponding at least two first stationary contacts to being connected to another adjacent first stationary contact of the corresponding at least two first stationary contacts, and the second movable connection end is switched from being connected to one second stationary contact to being connected to another adjacent second stationary contact.

In this way, by operating the single manipulation portion, the first movable connection end and the second movable connection end can be driven to move together, thereby achieving dual adjustment of the color temperature and power of the lighting device. In the case that the selector switch comprises two first switching elements, the selector switch may be a three-pole multi-throw switch.

According to another aspect of the present application, provided is a control circuit for a lighting device, the control circuit comprising: the control unit for a lighting device as described above; and a drive circuit for the lighting device, the drive circuit being connected to the control unit, wherein the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is grounded via a grounding resistor inside the constant-current driver chip; wherein the constant-current driver chip is configured to compare a detected first voltage at the current detection terminal with a threshold voltage to control a current flowing through the current input terminal, the threshold voltage being determined according to a detected second voltage at the voltage detection terminal.

According to still another aspect of the present application, provided is a control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is connected to the current input terminal via a second external resistor and is grounded via a grounding resistor inside the constant-current driver chip; and the control unit comprises: a plurality of switching resistors, wherein each of the switching resistors comprises a first end and a second end, the first end of each of the switching resistors is grounded, and resistance values of at least two switching resistors of the plurality of switching resistors are different from each other; a floating terminal without electrical connection; and a selector switch, which is operable to connect the current input terminal to the second end of at least one lamp load of the plurality of lamp loads, while connecting the voltage detection terminal to the second end of any one switching resistor of the plurality of switching resistors or to the floating terminal; wherein the constant-current driver chip is configured to compare a detected first voltage at the current detection terminal with a threshold voltage to control a current flowing through the current input terminal, the threshold voltage being determined according to a detected second voltage at the voltage detection terminal.

In this way, by operating a single selector switch, the current input terminal can be switched to be connected to different lamp loads of the plurality of lamp loads or connected to at least two lamp loads via paths of different resistance values so as to adjust the color temperature of the lighting device, and also the voltage input terminal can be switched to be connected to different resistors of the plurality of switching resistors so as to adjust the power of the lighting device. Thus, a single selector switch is used to realize dual adjustment of color temperature and power, thereby simplifying the structural design of the lighting device, while reducing the cost of the lighting device.

Further, according to an embodiment of the present application, the selector switch comprises a manipulation portion, at least one first switching element and one second switching element. Each first switching element of the at least one first switching element comprises a first fixed connection end and a first movable connection end, and the second switching element comprises a second fixed connection end and a second movable connection end; wherein the at least one first fixed connection end of the at least one first switching element is connected to the current input terminal, and the second fixed connection end is connected to the voltage detection terminal, and the second movable connection end and the at least one first movable connection end of the at least one first switching element are both mechanically connected to the manipulation portion.

Further, according to an embodiment of the present application, the selector switch comprises one first switching element, and the selector switch is operable to connect the current input terminal to the second end of any one lamp load of the plurality of lamp loads, while connecting the voltage detection terminal to the second end of any one switching resistor of the plurality of switching resistors or to the floating terminal; the selector switch further comprises a plurality of first stationary contacts and a plurality of second stationary contacts, the second end of each of the plurality of lamp loads is connected to at least one first stationary contact of the plurality of first stationary contacts via at least one independent first path, the second end of each of the plurality of switching resistors is connected to at least one second stationary contact of the plurality of second stationary contacts via at least one independent second path, and the floating terminal serves as an additional second stationary contact of the plurality of second stationary contacts; and the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor or to the second stationary contact which is the floating terminal.

Further, according to an embodiment of the present application, the first fixed connection end of the first switching element and the second fixed connection end of the second switching element are configured to be immovable, and the first movable connection end and the second movable connection end are configured to rotate together; and the plurality of first stationary contacts are arranged around the first fixed connection end at predetermined intervals, and the plurality of second stationary contacts and the floating terminal are arranged around the second fixed connection end at the predetermined intervals, such that when the first movable connection end and the second movable connection end move together by the predetermined interval, the first movable connection end switches from being connected to one first stationary contact to being connected to another adjacent first stationary contact, and the second movable connection end switches from being connected to one second stationary contact to being connected to another adjacent second stationary contact.

Further, according to an embodiment of the present application, the selector switch comprises at least two first switching elements, and the selector switch is operable to connect the current input terminal to the second ends of any two lamp loads of the plurality of lamp loads, while connecting the current input terminal to the second end of any one switching resistor of the plurality of switching resistors; the selector switch further comprises a plurality of first stationary contacts and a plurality of second stationary contacts, the second end of each of the at least two lamp loads is connected to at least two first stationary contacts of the plurality of first stationary contacts via at least two independent first paths, and resistance values of the at least two independent first paths are different from each other or partially different from each other; the second end of each of the plurality of switching resistors is connected to at least one second stationary contact of the plurality of second stationary contacts via at least one independent second path; the floating terminal serves as an additional second stationary contact of the plurality of second stationary contacts; and the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor, or to the second stationary contact which is the floating terminal.

Further, according to an embodiment of the present application, the at least two first fixed connection ends of the at least two first switching elements and the second fixed connection end of the second switching element are configured to be immovable, and the second movable connection end and the at least two first movable connection ends are configured to rotate together; and the at least two first stationary contacts to which the second end of each lamp load of the at least two lamp loads is connected are arranged around a corresponding first fixed connection end of the at least two first fixed connection ends at predetermined intervals, and the plurality of second stationary contacts are arranged around the second fixed connection end at the predetermined intervals, such that when the second movable connection end and the at least two first movable connection ends move together by the predetermined interval, each first movable connection end of the at least two first movable connection ends is switched from being connected to one first stationary contact of the corresponding at least two first stationary contacts to being connected to another adjacent first stationary contact of the corresponding at least two first stationary contacts, and the second movable connection end is switched from being connected to one second stationary contact to being connected to another adjacent second stationary contact.

According to still another aspect of the present application, provided is a control circuit for a lighting device, the control circuit comprising: the control unit for a lighting device as described above; and a drive circuit for the lighting device, the drive circuit being connected to the control unit, the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is connected to the current input terminal via a second external resistor and is grounded via a grounding resistor inside the constant-current driver chip; wherein the constant-current driver chip is configured to compare a detected first voltage at the current detection terminal with a threshold voltage to control a current flowing through the current input terminal, the threshold voltage being determined according to a detected second voltage at the voltage detection terminal.

According to still another aspect of the present application, provided is a control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a current detection terminal and a current input terminal, wherein the current detection terminal and the current input terminal are connected inside the constant-current driver chip; and the control unit comprises: a plurality of switching resistors, wherein each of the switching resistors comprises a first end and a second end, the first end of each of the switching resistors is grounded, and resistance values of at least two switching resistors of the plurality of switching resistors are different from each other; and a selector switch, which is operable to connect the current input terminal to the second end of at least one lamp load of the plurality of lamp loads, while connecting the current detection terminal to the second end of any one switching resistor of the plurality of switching resistors; wherein the constant-current driver chip is configured to compare a detected first voltage at the current detection terminal with a fixed threshold voltage to control a current flowing through the current input terminal.

In this way, by operating a single selector switch, the current input terminal can be switched to be connected to different lamp loads of the plurality of lamp loads or connected to at least two lamp loads via paths of different resistance values so as to adjust the color temperature of the lighting device, and also the current input terminal can be switched to be connected to different resistors of the plurality of switching resistors so as to adjust the power of the lighting device. Thus, a single selector switch is used to realize dual adjustment of color temperature and power, thereby simplifying the structural design of the lighting device, while reducing the cost of the lighting device.

Further, according to an embodiment of the present application, the plurality of switching resistors comprise a first switching resistor, the second end of the first switching resistor being connected to the current detection terminal.

In this way, a resistor in parallel connection with the first switching resistor can be changed by operating the selector switch to change the magnitude of a resistance value between the current detection terminal and the ground, thereby changing the power of the lighting device.

Further, according to an embodiment of the present application, the constant-current driver chip further comprises a voltage detection terminal, the voltage detection terminal being grounded via a grounding resistor inside the constant-current driver chip.

In this way, when the constant-current driver chip has the voltage detection terminal, the power of the lighting device may also be adjusted by changing the magnitude of the resistance value between the current detection terminal and the ground.

Further, according to an embodiment of the present application, the selector switch comprises a manipulation portion, at least one first switching element and one second switching element. Each first switching element of the at least one first switching element comprises a first fixed connection end and a first movable connection end, and the second switching element comprises a second fixed connection end and a second movable connection end; wherein the at least one first fixed connection end of the at least one first switching element is connected to the current input terminal, and the second fixed connection end is connected to the current detection terminal, and the second movable connection end and the at least one first movable connection end of the at least one first switching element are both mechanically connected to the manipulation portion.

Further, according to an embodiment of the present application, the selector switch comprises one first switching element, and the selector switch is operable to connect the current input terminal to the second end of any one lamp load of the plurality of lamp loads, while connecting the current detection terminal to the second end of any one switching resistor of the plurality of switching resistors; the selector switch further comprises a plurality of first stationary contacts and a plurality of second stationary contacts, the second end of each of the plurality of lamp loads is connected to at least one first stationary contact of the plurality of first stationary contacts via at least one independent first path, the second end of each of the plurality of switching resistors is connected to at least one second stationary contact of the plurality of second stationary contacts via at least one independent second path, and the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor.

Further, according to an embodiment of the present application, the selector switch comprises at least two first switching elements, and the selector switch is operable to connect the current input terminal to the second ends of any two lamp loads of the plurality of lamp loads, while connecting the current detection terminal to the second end of any one switching resistor of the plurality of switching resistors; and the selector switch further comprises a plurality of first stationary contacts and a plurality of second stationary contacts, the second end of each of the at least two lamp loads is connected to at least two first stationary contacts of the plurality of first stationary contacts via at least two independent first paths, and resistance values of the at least two independent first paths are different from each other or partially different from each other; the second end of each of the plurality of switching resistors is connected to at least one second stationary contact of the plurality of second stationary contacts via at least one independent second path; and the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor.

According to still another aspect of the present application, provided is a control circuit for a lighting device, the control circuit comprising: the control unit for a lighting device as described above; and a drive circuit for the lighting device, the drive circuit being connected to the control unit, wherein the drive circuit comprises a constant-current driver chip, the constant-current driver chip comprising a current detection terminal and a current input terminal, wherein the current detection terminal and the current input terminal are connected inside the constant-current driver chip; wherein the constant-current driver chip is configured to compare a detected first voltage at the current detection terminal with a fixed threshold voltage to control a current flowing through the current input terminal.

According to still another aspect of the present application, provided is a lighting device, comprising: the control circuit for a lighting device as described above; and a bulb housing, enclosing the control circuit; wherein a selector switch of the control circuit comprises a single manipulation portion which can be manually operated, and the manipulation portion is arranged on the bulb housing.

In this way, a user can conveniently achieve dual adjustment of color temperature and power of the lighting device by operating the single manipulation portion on the bulb housing. In addition, since such a lighting device only needs to arrange a single manipulation portion on the bulb housing, the appearance of the lighting device is more concise, thereby improving the aesthetics of the lighting device.

Further, according to an embodiment of the present application, the manipulation portion comprises any one of: a toggle lever, a slide lever, a button or a knob.

In this way, an appropriate manipulation portion can be selected according to the shape and manipulation requirements of the bulb housing, so as to facilitate the operation of the manipulation portion by the user.

In embodiments of the present application, provided is a control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is grounded via a grounding resistor inside the constant-current driver chip; and the control unit comprises: a plurality of switching resistors, wherein each of the switching resistors comprises a first end and a second end, the first end of each of the switching resistors is connected to the voltage detection terminal, and resistance values of at least two switching resistors of the plurality of switching resistors are different from each other; and a selector switch, which is operable to connect the current input terminal to the second end of at least one lamp load of the plurality of lamp loads, while connecting the current input terminal to the second end of any one switching resistor of the plurality of switching resistors; wherein the constant-current driver chip is configured to compare a detected first voltage at the current detection terminal with a threshold voltage to control a current flowing through the current input terminal, the threshold voltage being determined according to a detected second voltage at the voltage detection terminal, so as to at least solve the technical problem in the prior art that it is difficult to achieve, using a simplified structural design, dual adjustment of color temperature and power of a lighting device using a constant-current driver chip, thereby achieving dual adjustment of color temperature and power of the lighting device merely by one switch, and achieving the technical effects of simplifying the structure of the lighting device and reducing the cost of the lighting device.

### BRIEF DESCRIPTION OF THE DRAWINGS

The drawings of the description, constituting a part of the present application, are used for providing further understanding of the present application, and the illustrative embodiments of the present application and illustrations thereof are used to explain the present application, rather than constitute inappropriate limitation on the present application. In the drawings:

FIG. 1 is a schematic diagram of a control unit for a lighting device and a control circuit comprising the control unit according to a first embodiment of the present application;

FIG. 2 is another schematic diagram of the control unit for a lighting device and the control circuit comprising the control unit according to the first embodiment of the present application;

FIG. 3 is still another schematic diagram of the control unit for a lighting device and the control circuit comprising the control unit according to the first embodiment of the present application;

FIG. 4 is still another schematic diagram of the control unit for a lighting device and the control circuit comprising the control unit according to the first embodiment of the present application;

FIG. 5 is a schematic diagram of a control unit for a lighting device and a control circuit comprising the control unit according to a second embodiment of the present application;

FIG. 6 is another schematic diagram of the control unit for a lighting device and the control circuit comprising the control unit according to the second embodiment of the present application;

FIG. 7 is a schematic diagram of a first example of a control unit for a lighting device and a control circuit comprising the control unit according to a third embodiment of the present application;

FIG. 8 is a schematic diagram of a second example of the control unit for a lighting device and the control circuit comprising the control unit according to the third embodiment of the present application;

FIG. 9 is a schematic diagram of a third example of the control unit for a lighting device and the control circuit comprising the control unit according to the third embodiment of the present application;

FIG. 10 is a schematic diagram of a fourth example of the control unit for a lighting device and the control circuit comprising the control unit according to the third embodiment of the present application;

FIG. 11 is a schematic diagram of a fifth example of the control unit for a lighting device and the control circuit comprising the control unit according to the third embodiment of the present application;

FIG. 12 is a schematic diagram of a sixth example of the control unit for a lighting device and the control circuit comprising the control unit according to the third embodiment of the present application;

FIG. 13 is a schematic diagram of a seventh example of the control unit for a lighting device and the control circuit comprising the control unit according to the third embodiment of the present application;

FIG. 14 is a schematic diagram of an eighth example of the control unit for a lighting device and the control circuit comprising the control unit according to the third embodiment of the present application;

FIG. 15 is an example of a selector switch included in a control unit for a lighting device according to embodiments of the present application; and

FIG. 16 is a schematic diagram of appearance of a lighting device according to exemplary embodiments of the present application.

### DETAILED DESCRIPTION

It is to be noted that embodiments in the present application and features in the embodiments may be combined with one another without conflicts. Hereinafter, the present application is described in detail with reference to the accompanying drawings and in conjunction with the embodiments.

It is to be noted that unless otherwise indicated, all technical and scientific terms used in the present application have the same meanings as those commonly understood by a person of ordinary skill in the art to which the present application belongs.

In the present application, unless specified to the contrary, directional terms such as “upper, lower, top and bottom” are generally used regarding the directions shown in the figures, or for the components themselves in vertical, perpendicular or gravity directions; likewise, for ease of understanding and description, “internal, external” refer to internal and external relative to the outline of each component itself, but the described directional terms are not used to limit the present application.

An object of the present application is to provide control units for lighting devices, control circuits comprising the control units, and lighting devices comprising the control circuits, which can realize dual adjustment of color temperature and power of a lighting device by a single switch, thereby simplifying the structural design of the lighting device, reducing the cost of the lighting device, and improving the aesthetics of the lighting device. In the present application, adjustment of color temperature and power can be performed between a plurality of gears, and changing from one gear to another adjacent gear can change color temperature only, or change power only, or change both color temperature and power.

The present application considers lighting devices using a constant-current driver chip, the constant-current driver chip comprising a current detection terminal and a current input terminal, wherein the current detection terminal is grounded via an external resistor, the current detection terminal and the current input terminal are connected inside the constant-current driver chip, and the current input terminal is connected to a power input end via a lamp load; and the constant-current driver chip uses a detected voltage at the current detection terminal to perform feedback control on a current flowing through a main loop composed of the lamp load, the current input terminal and the current detection terminal, such that the voltage at the current detection terminal is at a desired threshold voltage, that is, the current of the main loop is at a desired current. The constant-current driver chip may or may not have a voltage detection terminal.

Further, the current detection terminal and the current input terminal may be connected inside the constant-current driver chip via another integrated device (e.g. a MOS transistor). A positive electrode of each of the lamp loads may be connected to the power input end via a pre-drive circuit.

The present application considers realizing dual adjustment of color temperature and power of the lighting device by the following methods:
1. As for color temperature, it can be adjusted in two ways:
   (1) a plurality of lamp loads (for example, the color temperature of each of which can be between 2700K-6500K) are provided, the color temperatures of at least two lamp loads of the plurality of lamp loads are different from each other, and by switching a lamp load to which the current input terminal is connected, the color temperature of the lighting device can be switched.
   (2) The current input terminal maintains to be simultaneously connected to at least two lamp loads (e.g. two lamp loads). By changing the resistance value of a connecting line between the current input terminal and each lamp load of the at least two lamp loads, currents flowing through the at least two lamp loads can be mixed at different ratios, thereby changing the color temperature of the lighting device.
2. As for power, the power of the lighting device is adjusted by changing the current flowing through the main loop formed by the lamp load, the current input terminal, and the current detection terminal. In order to change the current flowing through the main loop, the following methods may be used:
   (1) When the constant-current driver chip has a voltage detection terminal, the voltage detection terminal is grounded via a grounding resistor inside the chip. On the one hand, when a voltage at the current detection terminal is compared with a varying threshold voltage (the varying threshold voltage depending on a voltage at the voltage detection terminal), the magnitude of the current flowing through the main loop may be changed by: i) changing the resistance value of a resistor connected between the voltage detection terminal and the current input terminal, or ii) changing the resistance value of a resistor connected between the voltage detection terminal and the ground (in this case, the voltage detection terminal needs to be connected to the current input terminal via a resistor). On the other hand, when the voltage at the current detection terminal is compared with a fixed threshold voltage, the magnitude of the current flowing through the main loop may be changed by iii) changing the resistance value of a resistor connected between the current detection terminal and the ground.
   (2) When the constant-current driver chip does not have a voltage detection terminal, the magnitude of the current flowing through the main loop may be changed by changing the resistance value of the resistor connected between the current detection terminal and the ground.

In the present application, in the described various methods for adjusting the color temperature and power of the lighting device, a single selector switch is used to adjust color temperature only, adjust power only, or adjust both the color temperature and power, thereby realizing dual adjustment of the color temperature and power of the lighting device by a single selector switch, such that the structural design of the lighting device is simplified.

Next, embodiments of realizing dual adjustment of color temperature and power using a single selector switch by using any one of the adjustment methods above will be described in detail with reference to the accompanying drawings.

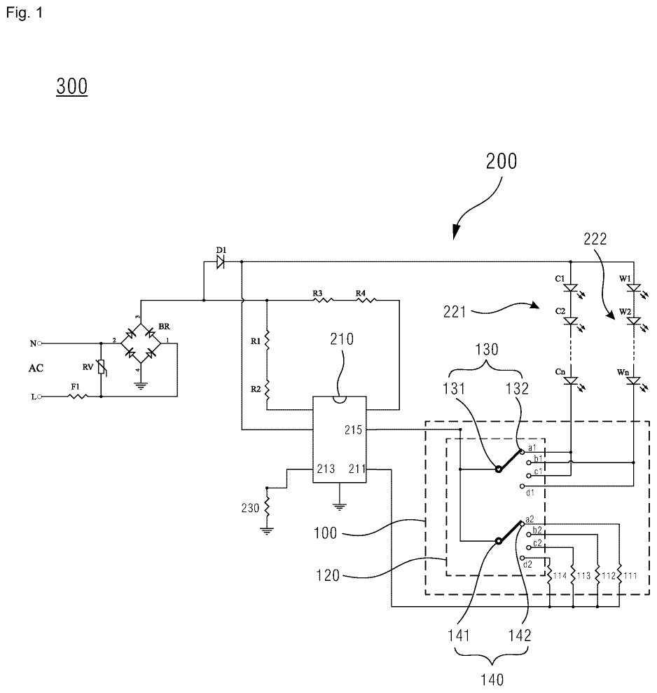

FIG. 1 is a schematic diagram of a control unit for a lighting device and a control circuit comprising the control unit according to a first embodiment of the present application. The first embodiment shows a case in which a voltage detection terminal is provided, and the power of the lighting device is adjusted by changing the resistance value of a resistor connected between the voltage detection terminal and a current input terminal. As shown in FIG. 1, a control circuit 300 for a lighting device according to the first embodiment of the present application comprises a control unit 100 and a drive circuit 200 for the lighting device. The lighting device comprises a plurality of lamp loads, wherein the color temperatures of at least two lamp loads of the plurality of lamp loads are different from each other, each of the lamp loads comprises a first end and a second end, and the first end of each of the lamp loads is connected to a power input end. The control unit 100 is connected to the drive circuit 200. The drive circuit 200 comprises a constant-current driver chip 210, the constant-current driver chip 210 comprising a voltage detection terminal 211, a current detection terminal 213 and a current input terminal 215; wherein the current detection terminal 213 is grounded via a first external resistor 230, the current detection terminal 213 and the current input terminal 215 are connected inside the constant-current driver chip 210, and the voltage detection terminal 211 is grounded via a grounding resistor inside the constant-current driver chip 210. The control unit 100 comprises: a plurality of switching resistors, wherein each of the switching resistors comprises a first end and a second end, the first end of each of the switching resistors is connected to the voltage detection terminal 211, and resistance values of at least two switching resistors of the plurality of switching resistors are different from each other; and a selector switch 120, which is operable to connect the current input terminal 215 to the second end of at least one lamp load of the plurality of lamp loads, while connecting the current input terminal 215 to the second end of any one switching resistor of the plurality of switching resistors; wherein the constant-current driver chip 210 is configured to compare a detected first voltage at the current detection terminal 213 with a threshold voltage to control a current flowing through the current input terminal 215, the threshold voltage being determined according to a detected second voltage at the voltage detection terminal 211.

Further, in the present application, the threshold voltage may be directly proportional or inversely proportional to the second voltage at the voltage detection terminal 211, and the ratio may be linear or non-linear. In brief, it suffices that the threshold voltage is determined by the second voltage.

It should be noted that, in FIG. 1, for clarity of illustration, only a first lamp load 221 and a second lamp load 222 are shown as an example of the plurality of lamp loads, the color temperatures of the first lamp load 221 and the second lamp load 222 are different from each other, and only a first switching resistor 111, a second switching resistor 112, a third switching resistor 113, and a fourth switching resistor 114 are shown as an example of the plurality of switching resistors. The resistance values of at least two resistors of the four resistors are different from each other. However, a person skilled in the art would have been aware that any number of resistors and any number of lamp loads can be set as actually needed, e.g. 3, 5, 8, 12, etc. The number of the plurality of switching resistors and the number of the plurality of lamp loads may be the same or different.

Moreover, the structure of the selector switch 120 shown in FIG. 1 is also merely an example. FIG. 1 shows that the selector switch 120 connects the current input terminal 215 to the second end of one of the lamp loads, and connects the current input terminal 215 to the second end of one of the switching resistors; however, the selector switch 120 can also connect the current input terminal 215 to the second ends of several, even all of the lamp loads, and connect the current input terminal 215 to the second end of the one of the switching resistors. In the present application, various structures of selector switches 120 can be used, as long as it can achieve the described functions.

Furthermore, in the present application, each lamp load may comprise one or more LEDs. In an exemplary embodiment, the color temperatures of the plurality of lamp loads are different from one another. In an exemplary embodiment, the resistance values of the plurality of switching resistors are different from one another.

Using the control unit 100 and the control circuit 300 comprising same as shown in FIG. 1, by operating the selector switch 120, the current input terminal 215 may be connected to the second end of at least one lamp load of the plurality of lamp loads (in the case of the two lamp loads shown in FIG. 1, only the second end of the first lamp load 221, or only the second end of the second lamp load 222, or the second ends of the first lamp load 221 and the second lamp load 222); and at the same time, the current input terminal 215 may be connected to the second end of any one switching resistor of the plurality of switching resistors (i.e. the second end of one of the switching resistors 111 to 114 in the figure), so as to achieve dual adjustment of the color temperature and power.

Power adjustment of the lighting device is based on the following principle: the current detection terminal 213 of the constant-current driver chip 210 is grounded via an external resistor 230. Therefore, the constant-current driver chip 210 can obtain a voltage drop across the external resistor 230 by detecting the first voltage at the current detection terminal 213, and in combination with a known resistance value of the external resistor 230, the magnitude of a current flowing through the connected lamp load, the current input terminal 215, the current detection terminal 213 and the external resistor 230 can be obtained. The constant-current driver chip 210 is configured to compare the detected first voltage at the current detection terminal 213 with the threshold voltage, and control the current flowing through the current input terminal 215 according to the comparison result, such that the first voltage at the current detection terminal 213 is equal to the threshold voltage. Since the threshold voltage is determined by the second voltage, the first voltage at the current detection terminal 213 is determined by the second voltage.

The threshold voltage being inversely proportional to the second voltage will be taken as an example for illustration. When the constant-current driver chip 210 detects that the second voltage increases, a control result thereof is to decrease the first voltage, which in turn decreases the current flowing through the lamp load, thereby decreasing the power of the lamp load. In addition, the second voltage at the voltage detection terminal 211 depends on the ratio of the resistance value of the grounding resistor inside the constant-current driver chip 210 to the resistance value of a resistor connected between the voltage detection terminal 211 and the current input terminal 215. Since the resistance value of the grounding resistor is fixed, the second voltage is substantially inversely proportional to the resistance value of the resistor connected between the voltage detection terminal 211 and the current input terminal 215.

When the resistance value of the resistor between the voltage detection terminal 211 and the current input terminal 215 increases, the second voltage decreases, and therefore the first voltage increases, and the current flowing through a main loop formed by the lamp load, the current input terminal 215, and the current detection terminal 213 increases. Thus, the power of the lighting device is increased. On the contrary, when the resistance value of the resistor between the voltage detection terminal 211 and the current input terminal 215 decreases, the second voltage increases, and therefore the first voltage decreases, and the current flowing through the main loop formed by the lamp load, the current input terminal 215, and the current detection terminal 213 decreases. Thus, the power of the lighting device is decreased.

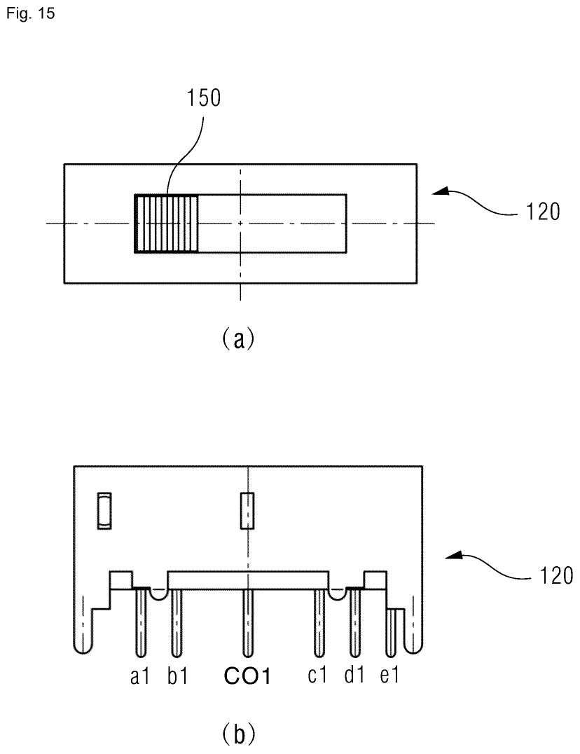

Further, as shown in FIGS. 1-4, the selector switch 120 may comprise at least one first switching element 130 and one second switching element 140. Each of the at least one first switching element 130 comprises a first fixed connection end 131 and a first movable connection end 132, and the second switching element 140 comprises a second fixed connection end 141 and a second movable connection end 142; wherein the second fixed connection end 141 and at least one first fixed connection end 131 of the at least one first switching element 130 are both connected to the current input terminal 215. The selector switch 120 is operable to connect at least one first movable connection end 132 of the at least one first switching element 130 to the second end of at least one lamp load of the plurality of lamp loads, respectively, and to also connect the second movable connection end 142 to the second end of any one switching resistor of the plurality of switching resistors. Thus, the current input terminal 215 can be connected to the second end of at least one lamp load of the plurality of lamp loads, and at the same time, the current input terminal 215 is connected to the second end of any one switching resistor of the plurality of switching resistors. The selector switch 120 may also comprise one manipulation portion 150 (as shown in FIG. 15), and both the at least one first movable connection end 132 and the second movable connection end 142 can be mechanically connected to the single manipulation portion 150. The manipulation portion 150 may be designed to be manually movable. Thus, a user can achieve connection switching of the at least one first movable connection end 132 and the second movable connection end 142 by operating the single manipulation portion 150, thereby achieving dual adjustment of the color temperature and power of the lighting device.

The structure of the selector switch 120 will be described below in two cases. The first case is that the selector switch 120 comprises one first switching element 130, and at this time, the selector switch 120 is operable to connect the current input terminal 215 to the second end of any one lamp load of the plurality of lamp loads, while connecting the current input terminal 215 to the second end of any one switching resistor of the plurality of switching resistors. In this case, the lamp load may be switched to switch the color temperature of the lighting device. The second case is that the selector switch 120 comprises at least two first switching elements, and at this time, the selector switch 120 is operable to connect the current input terminal 215 to the second ends of at least two lamp loads of the plurality of lamp loads, while connecting the current input terminal 215 to the second end of any one switching resistor of the plurality of switching resistors. In this case, currents flowing through the at least two lamp loads may be mixed at different ratios, thereby changing the color temperature of the lighting device.

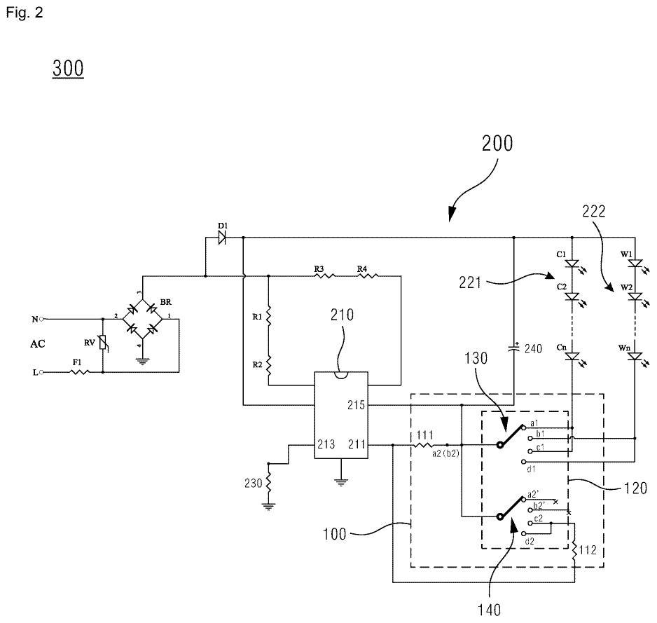

In the first case, as shown in FIGS. 1 and 2, the selector switch 120 comprises one first movable connection end 132 and one second movable connection end 142. In an exemplary embodiment, the selector switch 120 may also comprise a plurality of first stationary contacts and a plurality of second stationary contacts. The second end of each of the plurality of lamp loads may be connected to at least one first stationary contact of the plurality of first stationary contacts via at least one independent first path. The second end of each of the plurality of switching resistors may be connected to at least one second stationary contact of the plurality of second stationary contacts via at least one independent second path. That is, the second end of each of the lamp loads can be connected to one first stationary contact, or the second end of each of lamp loads can be connected to several first stationary contacts via several independent first paths. Similarly, the second end of each of the switching resistors can be connected to one second stationary contact, or the second end of each of the switching resistors can be connected to several second stationary contacts via several independent second paths. The second end of each of the lamp loads and corresponding at least one first stationary contact may be connected via a conductive wire, and the second end of each of the switching resistors and corresponding at least one second stationary contact may be connected via a conductive wire.

The first fixed connection end 131 and the second fixed connection end 141 may be configured to be immovable, and the first movable connection end 132 and the second movable connection end 142 may be configured to be movable together. The operation on the manipulation portion 150 can drive the first movable connection end 132 and the second movable connection end 142 to move together. One of the first stationary contacts and one of the second stationary contacts may constitute one gear of the selector switch 120 for connecting to the first movable connection end 132 and the second movable connection end 142. Each time the selector switch 120 is operated to switch one gear, the first movable connection end 132 is switched from being connected to the current first stationary contact to being connected to another adjacent first stationary contact, and the second movable connection end 142 is switched from being connected to the current second stationary contact to being connected to another adjacent second stationary contact.

By operating the selector switch 120 such that the first movable connection end 132 is connected to any of the first stationary contacts connected to the second end of any one lamp load, and the second movable connection end 142 is connected to any of the second stationary contacts which are connected to the second end of any one switching resistor, the current input terminal 215 can be connected to the second end of the any one lamp load, and at the same time, the current input terminal 215 can be connected to the second end of the any one switching resistor.

In the case that the second end of each lamp load is connected to only one first stationary contact and the second end of each switching resistor is connected to only one second stationary contact, if the manipulation portion 150 of the selector switch 120 is operated such that the first movable connection end 132 and the second movable connection end 142 are switched from being connected to one gear to being connected to another gear, then the color temperature and power of the lighting device will change.

In the case that the second end of each of the lamp loads is connected to several first stationary contacts respectively, the power can be switched stage by stage while keeping the color temperature unchanged. The number of first stationary contacts to which the second end of each lamp load is connected may or may not be equal to the number of switching resistors. Similarly, in the case that the second end of each switching resistor is connected to several second stationary contacts respectively, the color temperature can be switched stage by stage while keeping the power unchanged. The number of second stationary contacts to which the second end of each switching resistor is connected may or may not be equal to the number of lamp loads.

FIG. 1 shows a case in which the second end of the first lamp load 221 is connected to two first stationary contacts a1 and c1 respectively via two independent first paths, the second end of the second lamp load 222 is connected to two first stationary contacts b1 and d1 respectively via two independent first paths, and the second ends of the four switching resistors 111 to 114 are connected to four second stationary contacts a2, b2, c2 and d2 respectively. In particular, FIG. 1 shows a state in which the first movable connection end 132 is connected to the first stationary contact a1 and the second movable connection end 142 is connected to the second stationary contact a2. Assuming that the resistance values of the first switching resistor 111 to the fourth switching resistor 114 are different from one another, then when the manipulation portion 150 of the selector switch 120 is operated such that the first movable connection end 132 is switched to be connected to the first stationary contact b1 and the second movable connection end 142 is switched to be connected to the second stationary contact b2, the color temperature of the lighting device is switched from the color temperature of the first lamp load 221 to the color temperature of the second lamp load 222, and the magnitude of a current flowing through the lamp load 222 changes, such that the power of the lighting device changes. On the other hand, when the selector switch 120 is operated such that the first movable connection end 132 is switched to be connected to the first stationary contact c1 and the second movable connection end 142 is switched to be connected to the second stationary contact c2, since both the first stationary contacts a1 and c1 are connected to the second end of the first lamp load 221, at this time, the color temperature of the lighting device does not change, and the power changes.

It should be noted that the connection relationship between the stationary contacts, the lamp loads and the switching resistors as shown in FIG. 1 is merely an example, and a person skilled in the art would have been aware that the relationship in quantity between the second ends of the lamp load and the first stationary contacts, and the relationship in quantity between the second ends of the switching resistor and the second stationary contacts can also be set in other manners according to gear requirements.

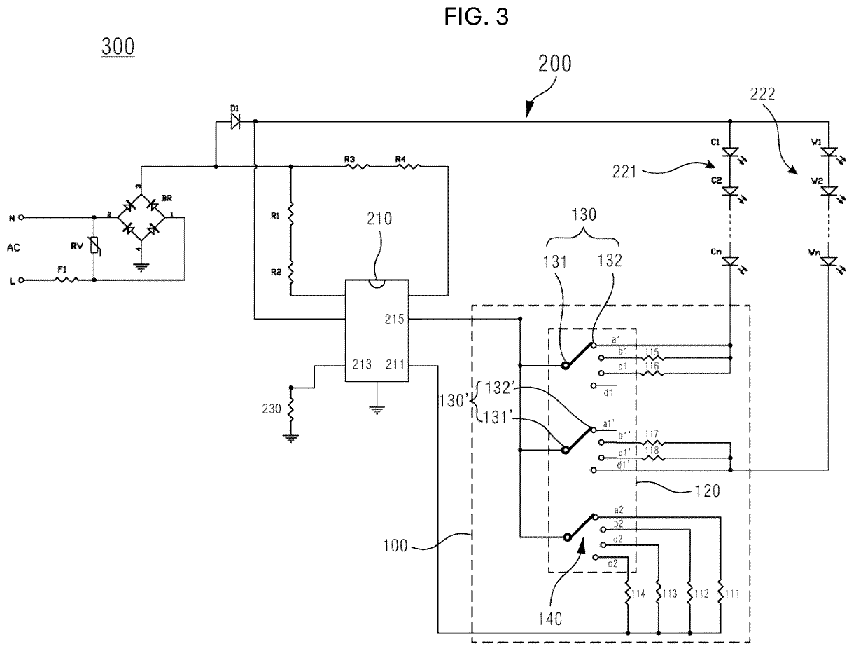

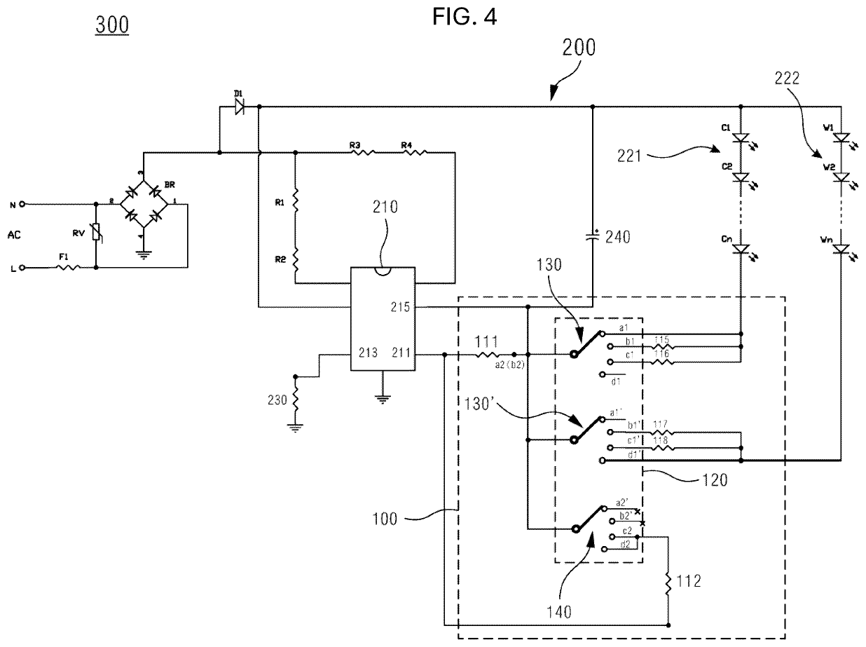

In the second case, as shown in FIGS. 3 and 4, the selector switch 120 comprises at least two first switching elements, and thus comprises at least two first movable connection ends and one second movable connection end 142. At this time, the selector switch 120 is operable to connect the at least two first movable connection ends to the second ends of at least two lamp loads of the plurality of lamp loads, respectively, and to also connect the second movable connection end 142 to the second end of any one switching resistor of the plurality of switching resistors. In FIG. 3, for simplicity, only two first switching elements are shown, and for distinguishing, the two first switching elements are shown as a first switching element 130 and a first switching element 130′ respectively, and a first fixed connection end of the first switching element 130′is denoted by 131′, and a first movable connection end thereof is denoted by 132′. However, when no distinguishing is required, the first switching element 130 and the first switching element 130′may be collectively referred to as the first switching element 130, two corresponding first movable connection ends may be collectively referred to as the first movable connection end 132, and two corresponding first fixed connection ends may be collectively referred to as the first fixed connection end 131. In an exemplary embodiment, the selector switch 120 may also comprise a plurality of first stationary contacts and a plurality of second stationary contacts. The second end of each of the at least two lamp loads may be connected to at least two first stationary contacts of the plurality of first stationary contacts via at least two independent first paths, and the resistance values of the at least two independent first paths are different from each other, or partially the same and partially different. The second end of each of the plurality of switching resistors may be connected to at least one second stationary contact of the plurality of second stationary contacts via at least one independent second path.

In the present application, the resistance values of the at least two independent first paths being different from each other or partially different from each other is achieved in the following manners: 1) The second end of the lamp load is directly connected (i.e. connecting only via a conductive wire) to a corresponding first stationary contact. As shown in FIG. 3, the second end of the lamp load 221 is directly connected to the first stationary contact a1, and at this time, the resistance value of the first path can be considered as 0. 2) The second end of the lamp load is connected to a corresponding first stationary contact via a resistor. As shown in FIG. 3, the second end of the lamp load 221 is connected to the first stationary contact b1 via a path resistor 115, and is connected to the first stationary contact c1 via a path resistor 116; at this time, the resistance value of a first path is the resistance value of the path resistor in the first path, and depending on gear requirements, the resistance values of the path resistor 115 and the path resistor 116 may be the same or different. 3) A floating terminal without electrical connection is provided as one first stationary contact corresponding to the second end of the lamp load. As shown in FIG. 3, the first stationary contact d1 is a floating terminal, and the resistance value of a first path corresponding thereto is considered to be infinite, that is, at this time, it is considered that the second end of the lamp load 221 is connected to the first stationary contact d1 via an infinite resistor. Similarly, FIG. 3 also shows that the second end of the lamp load 222 is connected to a first stationary contact a1′ which is a floating terminal via an infinite resistor, the second end of the lamp load 222 is connected to a first stationary contact b1′ via a path resistor 117, the second end of the lamp load 222 is connected to a first stationary contact c1′ via a path resistor 118, and the second end of the lamp load 222 is directly connected to a first stationary contact d1′ via a conductive wire.

The second fixed connection end 141 and at least two first fixed connection ends 131 may be configured to be immovable, and the second movable connection end 142 and at least two first movable connection ends 132 may be configured to be movable together. The plurality of first stationary contacts may be divided into at least two groups of first stationary contacts relative to the at least two lamp loads, each group of first stationary contacts corresponding to one first switching element. Each group of first stationary contacts may be arranged around a corresponding first fixed connection end at predetermined intervals, and the plurality of second stationary contacts may be arranged around the second fixed connection end at predetermined intervals. At least two first stationary contacts respectively from the at least two groups of first stationary contacts, together with one second stationary contact, may constitute one gear of the selector switch 120. Each time the selector switch 120 is operated to switch one gear and move by the predetermined interval, the first movable connection end 132 of each first switching element is switched from being connected to the current first stationary contact to being connected to another adjacent first stationary contact in the group of first stationary contacts, and the second movable connection end 142 is switched from being connected to the current second stationary contact to being connected to another adjacent second stationary contact. Thus, the manipulation portion 150 is operable, such that each first movable connection end of the at least two first movable connection ends is connected to any of the first stationary contacts of a corresponding group of first stationary contacts (i.e. the group of first stationary contacts connected to the second end of a corresponding lamp load of the at least two lamp loads), and at the same time, the second movable connection end of the second switching element is connected to any of the second stationary contacts which are connected to the second end of any one switching resistor.

FIG. 3 shows a state in which the first movable connection end 132 of the first switching element 130 is connected to the first stationary contact a1, the first movable connection end 132′of the first switching element 130′is connected to the first stationary contact a1′, and the second movable connection end 142 is connected to the second stationary contact a2. At this time, the color temperature of the lighting device is the color temperature of the lamp load 221, and the power of the lighting device is determined by the first switching resistor 111.

When the manipulation portion 150 is operated such that the first movable connection end 132 of the first switching element 130 is connected to the first stationary contact b1, the first movable connection end 132′of the first switching element 130′is connected to the first stationary contact b1′, and the second movable connection end 142 is connected to the second stationary contact b2, the color temperature of the lighting device is an equivalent color temperature obtained by mixing the color temperature of the lamp load 221 and the color temperature of the lamp load 222, the mixing ratio depends on the current flowing through each lamp load and a corresponding first path, in other words, the resistance value of the first path to which the first movable connection end of the corresponding first switching element is connected. In this case, the power of the lighting device is determined by the second switching resistor 112.

In the exemplary embodiment as shown in FIG. 3, the color temperatures of the two lamp loads 221 and 222 are set as appropriate color temperatures (e.g. 2700K and 6500K, respectively), and multiple first paths with different resistance values are provided for each lamp load, thus merely by combining the two lamp loads with the plurality of switching resistors, dual adjustment of the color temperature and power of the lighting device can be achieved, and the color temperature of the lighting device can be changed to any suitable color temperature between 2700K-6500K.

That is, compared with the first case, in the second case, dual adjustment of the color temperature and power of the lighting device can also be realized, and the number of the lamp loads can be reduced, thereby reducing the cost of the lighting device.

As a single manipulation portion 150 for controlling the second movable connection end 142 and the at least one first movable connection end 132, the manipulation portion 150 can be realized as a toggle lever, a slide lever, a button or a knob. Depending on the form of the manipulation portion 150 being used, the selector switch 120 may be realized as a toggle switch, a slide switch, a push switch or a rotary switch.

The selector switch 120 may be a multi-pole multi-throw switch. When the selector switch 120 comprises one first switching element 130, the selector switch 120 may be a double-pole multi-throw switch. When the selector switch 120 comprises two or more first switching elements 130, the selector switch 120 may be a three-pole multi-throw switch, a four-pole multi-throw switch, etc. The number of “poles” in the selector switch 120 may be equal to the total number of the first switching element 130 and the second switching element 140.

Next, a specific structure of the selector switch 120 capable of realizing the connection switching between the at least one first movable connection end 132 and the first stationary contacts, and between the second movable connection end 142 and the second stationary contacts is described with reference to FIG. 15. FIG. 15 is an example of the selector switch included in the control unit for a lighting device according to embodiments of the present application. As an example, FIG. 15 shows a selector switch 120 implemented as a toggle switch. (a) of FIG. 15 shows a schematic top view of the selector switch 120, and (b) of FIG. 15 shows a sectional side view of the selector switch 120. As shown in (a) of FIG. 15, the manipulation portion 150 is arranged on a housing of the selector switch 120, and can be manually operated to make step movement in a first direction (the horizontal direction in the figure). The first stationary contacts and the second stationary contacts are exposed from the lower portion of the housing, and are respectively arranged at predetermined intervals in the first direction. The predetermined interval may correspond to a movement step length of the first movable connection end 132 and the second movable connection end 142. (b) of FIG. 15 shows five first stationary contacts a1, b1, c1, d1, and e1 arranged in the first direction. Five second stationary contacts (not shown in the figure) are correspondingly arranged on the inner side of the five first stationary contacts along the paper plane direction. In addition, in the case that the selector switch 120 comprises at least two first switching elements, on the inner side along the paper plane direction, other multiple groups of first stationary contacts corresponding to the first movable connection ends of other first switching elements are also arranged correspondingly. These first stationary contacts and second stationary contacts make up 5 gears. A first fixed contact CO1 is further exposed from the lower portion of the housing (a second fixed contact is further arranged on the inner side of the CO1 along the paper plane direction; and in the case where the selector switch 120 comprises at least two first switching elements, there are also other first fixed contacts). The first fixed connection end 131 is fixedly or movably connected to the first fixed contact CO1. Similarly, the second fixed connection end 141 (which is located within the housing of the selector switch 120) is fixedly or movably connected to the second fixed contact.

Therefore, when the user operates the manipulation portion 150 to move, the manipulation portion drives the second movable connection end 142 and the at least one first movable connection end 132 (these connection ends being all located in the housing of the selector switch 120) to move together in the first direction, thereby achieving connection switching of the second movable connection end 142 and the at least one first movable connection end 132 between different gears.

In an exemplary embodiment of the present application, the current input terminal 215 may be connected to the positive electrode of the lamp load via a capacitor 240. The capacitor 240 may be used to filter the lamp load.

Further, in an exemplary embodiment, the second end of one of the plurality of switching resistors may be connected to the current input terminal 215. FIG. 2 is another schematic diagram of the control unit for a lighting device and the control circuit comprising the control unit according to the first embodiment of the present application. For clarity of illustration, FIG. 2 shows the case of two switching resistors 111 and 112 and two lamp loads 221 and 222 as an example. The control unit 100 and the control circuit 300 in FIG. 2 are obtained by further connecting the second end of the first switching resistor 111 in FIG. 1 to the current input terminal 215. In addition, FIG. 2 shows that the number of the switching resistors and the correspondence relationship between the number of the switching resistors and the number of the second stationary contacts are different from those in FIG. 1. However, a person skilled in the art would have been aware that the number of the switching resistors and the correspondence relationship between the number of the switching resistors and the number of the second stationary contacts can be set randomly according to requirements, and what is shown in the figures is an example, and is not limited in the present application.

As shown in FIG. 2, the second end of the first switching resistor 111 is connected to the current input terminal 215, and the current input terminal 215 is connected to the positive electrode of the lamp load via the capacitor 240; and the positive electrode of the lamp load is connected to the power input end via the pre-drive circuit, and thus the voltage detection terminal 211 can be prevented from being in a floating state in the process of connection switching of the selector switch 120. In this way, it is possible to prevent the voltage detection terminal 211 in a floating state from introducing noise or interference signals to the constant-current driver chip.

When the second movable connection end 142 of the selector switch 120 is connected to the second end of the first switching resistor 111, the resistance value between the voltage detection terminal 211 and the current input terminal 215 is the largest, the second voltage at the voltage detection terminal 211 is the smallest, and when the threshold voltage is inversely proportional to the second voltage, the current flowing through the current input terminal 215 and the lamp load is the largest, at this time, the lighting device is in a maximum power state. When the second movable connection end 142 of the selector switch 120 is switched to be connected to the second end (i.e. the second stationary contact c2 or d2) of the second switching resistor 112, the resistance value between the voltage detection terminal 211 and the current input terminal 215 is an equivalent resistance value of the first switching resistor 111 and the second switching resistor 112 after being connected in parallel; and as the equivalent resistance value after parallel connection decreases, the power of the lighting device also decreases.

In an exemplary embodiment, according to the actual requirement for power adjustment, at least one floating terminal without any electrical connection is provided as at least one second stationary contact to which the second end of the first switching resistor 111 is connected. FIG. 2 shows two floating terminals a2′ and b2′ as an example. When the second movable connection end 142 is connected to any one of the second stationary contacts a2′ and b2′ which are floating terminals, only the first switching resistor 111 is connected between the voltage detection terminal 211 and the current input terminal 215, at this time, it is equivalent to the second movable connection end 142 being connected to the second end of the first switching resistor 111.

In the example of FIG. 2, the selector switch 120 comprises four first stationary contacts and four second stationary contacts which make up four gears. The second end of the first lamp load 221 is connected to the two first stationary contacts a1 and c1, the second end of the second lamp load 222 is connected to the two first stationary contacts b1 and d1, and the second end of the second switching resistor 112 is connected to the two second stationary contacts c2 and d2. FIG. 2 shows a state in which the first movable connection end 132 is connected to the first stationary contact a1 and the second movable connection end 142 is connected to the second stationary contact a2′. When one gear is to be switched such that the first movable connection end 132 is connected to the first stationary contact b1 and the second movable connection end 142 is connected to the second stationary contact b2′, the power of the lighting device does not change, but the color temperature thereof changes.

It should be noted that the arrangements of the first stationary contacts and the second stationary contacts shown in FIG. 2 is merely an example, and the arrangements of various first stationary contacts and second stationary contacts described above with reference to FIG. 1 may also be used.

Furthermore, FIG. 2 shows a case in which the selector switch 120 comprises one first switching element 130. Similar to that described with reference to FIG. 3, in the control unit 100 and the control circuit 300 shown in FIG. 2, the selector switch 120 also comprises at least two first switching elements 130. FIG. 4 is still another schematic diagram of the control unit for a lighting device and the control circuit comprising the control unit according to the first embodiment of the present application. The control unit 100 and the control circuit 300 shown in FIG. 4 are similar to those shown in FIG. 2, and the differences lie in that: the selector switch 120 comprises two first switching elements 130 and 130′, and the first lamp load 221 is connected to the four first stationary contacts a1, b1, c1 and d1 respectively via four first paths having different resistance values, and the second lamp load 222 is connected to the four first stationary contacts a1′, b1′, c1′, and d1′ respectively via four other first paths having different resistance values. Adjustment of the color temperature of the lighting device by the control unit 100 and the control circuit 300 shown in FIG. 4 is similar to that described with reference to FIG. 3, and adjustment of the power of the lighting device is similar to that described with reference to FIG. 2, and therefore they will not be repeated herein.

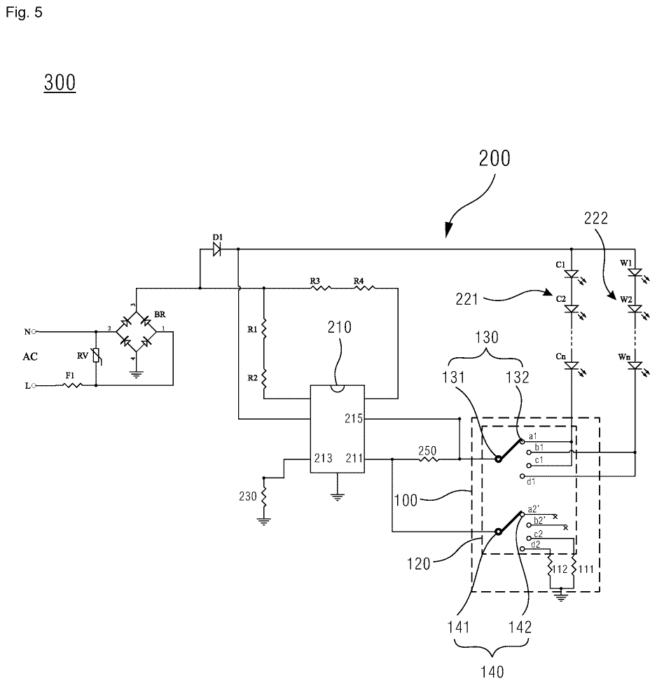

Next, other embodiments of a control unit 100 and a control circuit 300 comprising same according to the present application will be described with reference to FIGS. 5 to 14.

FIG. 5 is a schematic diagram of a control unit for a lighting device and a control circuit comprising the control unit according to a second embodiment of the present application. The second embodiment shows a case in which a constant-current driver chip 210 has a voltage detection terminal, and the power of the lighting device is adjusted by changing the resistance value of an equivalent resistor connected between the voltage detection terminal and the ground. In this case, the voltage detection terminal needs to be connected to a current input terminal via a resistor. As shown in FIG. 5, the control circuit 300 for a lighting device according to the second embodiment of the present application comprises a control unit 100 and a drive circuit 200 for the lighting device. The lighting device comprises a plurality of lamp loads, the color temperatures of at least two lamp loads of the plurality of lamp loads are different from each other; each of the lamp loads comprises a first end and a second end, and the first end of each of the lamp loads is connected to a power input end. The control unit 100 is connected to the drive circuit 200. The drive circuit 200 comprises a constant-current driver chip 210, the constant-current driver chip 210 comprising a voltage detection terminal 211, a current detection terminal 213 and a current input terminal 215; wherein the current detection terminal 213 is grounded via a first external resistor 230, the current detection terminal 213 and the current input terminal 215 are connected inside the constant-current driver chip 210 (for example, via a MOS transistor), and the voltage detection terminal 211 is connected to the current input terminal 215 via a second external resistor 250 and is grounded via a grounding resistor inside the constant-current driver chip 210. The control unit 100 comprises: a plurality of switching resistors, wherein each of the switching resistors comprises a first end and a second end, the first end of each of the switching resistors is grounded, and resistance values of at least two switching resistors of the plurality of switching resistors are different from each other; a floating terminal without electrical connection; and a selector switch 120, the selector switch 120 being operable to connect the current input terminal 215 to the second end of at least one lamp load of the plurality of lamp loads while connecting the voltage detection terminal 211 to the second end of any one switching resistor of the plurality of switching resistors or to the floating terminal; wherein the constant-current driver chip 210 is configured to compare a detected first voltage at the current detection terminal 213 with a threshold voltage to control a current flowing through the current input terminal 215, the threshold voltage being determined according to a detected second voltage at the voltage detection terminal 211.

Similar to the first embodiment, in the second embodiment, the threshold voltage may be directly proportional or inversely proportional to the second voltage at the voltage detection terminal 211, and the ratio may be linear or non-linear. In brief, it suffices that the threshold voltage is determined by the second voltage.

Using the control unit 100 and the control circuit 300 comprising same as shown in FIG. 5, by operating the selector switch 120, the current input terminal 215 can be connected to the second end of at least one lamp load of the plurality of lamp loads, and at the same time, the voltage detection terminal 211 can be connected to the second end of any one switching resistor of the plurality of switching resistors (i.e. the second end of one of switching resistors 111 and 112 in the figure) or to the floating terminal (i.e. a2′ or b2′ in the figure). By connecting to a different single lamp load or by connecting to at least two lamp loads respectively via different resistors, the color temperature of the lighting device can be changed. The resistance value of the equivalent resistor between the voltage detection terminal 211 and the ground can be changed by connecting different switching resistors between the voltage detection terminal 211 and the ground. When the resistance value of the equivalent resistor between the voltage detection terminal and the ground changes, the second voltage (the second voltage being substantially directly proportional to the resistance value between the voltage detection terminal and the ground) at the voltage detection terminal changes accordingly, and consequently, the magnitude of a current flowing through the lamp load changes, and the power of the lighting device also changes. Thus, by operating the single selector switch 120, dual adjustment of the color temperature and power of the lighting device can be achieved.

In FIG. 5, the current input terminal 215 may also be connected to a positive electrode of the lamp load via a capacitor (not shown).

Similar to the first embodiment, in the control unit 100 according to the second embodiment, the selector switch 120 may also comprise one first switching element 130 and one second switching element 140. The first switching element 130 comprises a first fixed connection end 131 and a first movable connection end 132, and the second switching element 140 comprises a second fixed connection end 141 and a second movable connection end 142; wherein the first fixed connection end 131 and the second fixed connection end 141 are both connected to the current input terminal 215. The selector switch 120 is operable to connect the first movable connection end 132 to the second end of any one lamp load of the plurality of lamp loads, while connecting the second movable connection end 142 to the second end of any one switching resistor of the plurality of switching resistors or to the floating terminal. Thus, the current input terminal 215 can be connected to the second end of at least one lamp load of the plurality of lamp loads, and at the same time, the voltage detection terminal 211 can be connected to the second end of any one switching resistor of the plurality of switching resistors or to the floating terminal. In addition, the first movable connection end 132 and the second movable connection end 142 may be controlled by a single manipulation portion 150. Thus, a user may achieve dual adjustment of the color temperature and power of the lighting device by operating the single manipulation portion 150.

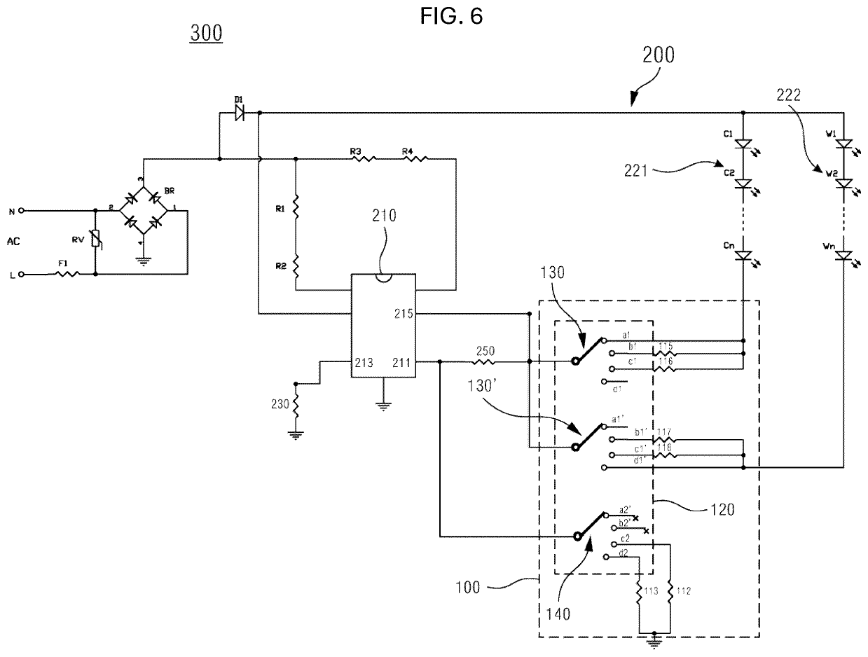

Similar to the first embodiment, in the control unit 100 according to the second embodiment, the selector switch 120 may also comprise at least two first switching elements 130 and one second switching element 140. FIG. 6 is another schematic diagram of the control unit for a lighting device and the control circuit comprising the control unit according to the second embodiment of the present application. FIG. 6 shows a case where the selector switch 120 shown in FIGS. 3 and 4 is employed in the control unit 100 according to the second embodiment. In FIG. 6, the color temperature adjustment method for the lighting device is the same as that described with reference to FIGS. 3 and 4, and the power adjustment method for the lighting device is the same as that described with reference to FIG. 5. That is, compared with FIG. 5, the control unit 100 and the control circuit as shown in FIG. 6 can reduce the number of lamp loads in the device and reduce the cost of the device while realizing dual adjustment of the color temperature and power of the lighting device.

It should be noted that in the second embodiment of the present application, the selector switch 120 (comprising the structures of the first switching element 130 and the second switching element 140 and the arrangements of first stationary contacts and second stationary contacts, and the floating terminal serving as a part of the plurality of second stationary contacts) may employ the selector switch 120 described with reference to the first embodiment. Therefore, details of the selector switch 120 in the second embodiment will not be repeated herein.

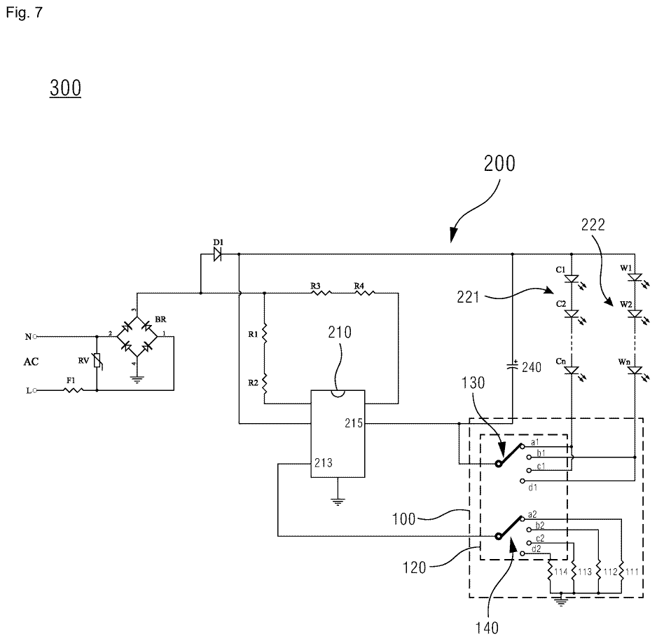

FIG. 7 is a schematic diagram of a first example of a control unit for a lighting device and a control circuit comprising the control unit according to a third embodiment of the present application. The third embodiment shows a case in which the power of the lighting device is adjusted by changing the resistance value of a resistor connected between a current detection terminal and the ground. At this time, different from the first embodiment and the second embodiment, the threshold voltage for comparison in the constant-current driver chip has a preset fixed value, and the constant-current driver chip may or may not have a voltage detection terminal. That is, in the third embodiment, the voltage detection terminal does not involve the power adjustment of the lighting device.

As shown in FIG. 7, the control circuit 300 for a lighting device according to the third embodiment of the present application comprises a control unit 100 and a drive circuit 200 for the lighting device. The lighting device comprises a plurality of lamp loads, the color temperatures of at least two lamp loads of the plurality of lamp loads are different from each other; each of the lamp loads comprises a first end and a second end, and the first end of each of the lamp loads is connected to a power input end. The control unit 100 is connected to the drive circuit 200. The drive circuit 200 comprises a constant-current driver chip 210, the constant-current driver chip 210 comprising a current detection terminal 213 and a current input terminal 215; wherein the current detection terminal 213 and the current input terminal 215 are connected inside the constant-current driver chip 210; and the control unit 100 comprises: a plurality of switching resistors, wherein each of the switching resistors comprises a first end and a second end, the first end of each of the switching resistors is grounded, and resistance values of at least two switching resistors of the plurality of switching resistors are different from each other; and a selector switch 120, which is operable to connect the current input terminal 215 to the second end of at least one lamp load of the plurality of lamp loads, while connecting the current detection terminal 213 to the second end of any one switching resistor of the plurality of switching resistors; wherein the constant-current driver chip 210 is configured to compare a detected first voltage at the current detection terminal 213 with a fixed threshold voltage to control a current flowing through the current input terminal 215.

In the first example shown in FIG. 7, the constant-current driver chip 210 does not have a voltage detection terminal 211. In addition, in the first example as shown in FIG. 7, the current input terminal 215 may also be connected to a positive electrode of the lamp load via a capacitor 240.

In the third embodiment of the present application, since the constant-current driver chip 210 compares the detected first voltage at the current detection terminal 213 with the fixed threshold voltage to control a current flowing through a main loop formed by the lamp load, the current input terminal 215 and the current detection terminal 213, the control result thereof is: the first voltage at the current detection terminal 213 is equal to the fixed threshold voltage.

Using the control unit 100 and the control circuit 300 comprising same as shown in the third embodiment of the present application, by operating the selector switch 120, the current input terminal 215 can be connected to the second end of at least one lamp load of the plurality of lamp loads, and at the same time, the current detection terminal 213 is connected to the second end of any one switching resistor of the plurality of switching resistors (i.e. the second end of one of switching resistors 111-114 in FIG. 7). By connecting to a different single lamp load or by connecting to at least two lamp loads respectively via different resistors, the color temperature of the lighting device can be changed. The resistance value of a resistor between the current detection terminal 213 and the ground can be changed by connecting different switching resistors between the current detection terminal 213 and the ground. When the resistance value of the resistor between the current detection terminal 213 and the ground increases, in order to enable the first voltage at the current detection terminal 213 to be equal to the fixed threshold voltage, the constant-current driver chip 210 controls to decrease the current of the main loop, thereby decreasing the power of the lighting device. Conversely, when the resistance value of the resistor between the current detection terminal 213 and the ground decreases, the constant-current driver chip 210 controls to increase the current of the main loop, thereby increasing the power of the lighting device. Thus, by operating the single selector switch 120, dual adjustment of the color temperature and power of the lighting device can be achieved.

Further, in an exemplary embodiment, the current input terminal 215 may be connected to the positive electrode of the lamp load via the capacitor 240.

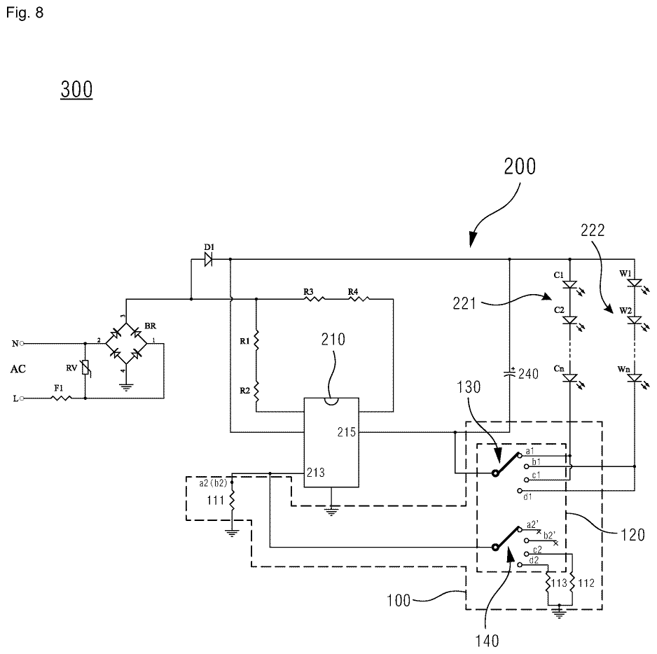

Further, in an exemplary embodiment, the second end of one of the plurality of switching resistors may be connected to the current input terminal 213. FIG. 8 is a schematic diagram of a second example of the control unit for a lighting device and the control circuit comprising the control unit according to the third embodiment of the present application. The control unit 100 and the control circuit 300 in FIG. 8 are obtained by further connecting the second end of the first switching resistor 111 in FIG. 7 to the current detection terminal 213.

In the case shown in FIG. 8, when the second movable connection end 142 of the selector switch 120 is connected to the second end of the first switching resistor 111, the resistance value between the current detection terminal 213 and the ground is the largest, such that the power of the lighting device is the smallest. When the second movable connection end 142 of the selector switch 120 is switched to be connected to the second end of the second switching resistor 112, since the first switching resistor 111 and the second switching resistor 112 are connected in parallel between the current detection terminal 213 and the ground, an equivalent resistance value decreases, such that the power of the lighting device increases.

Further, in an exemplary embodiment, similar to that described with reference to FIG. 2, at least one floating terminal (illustrated by a2′ and b2′ in FIG. 8) without any electrical connection may be provided depending on the actual requirement of power adjustment, and the floating terminal is considered as at least one second stationary contact (illustrated by a2 and b2 in FIG. 8) to which the second end of the first switching resistor 111 is connected.

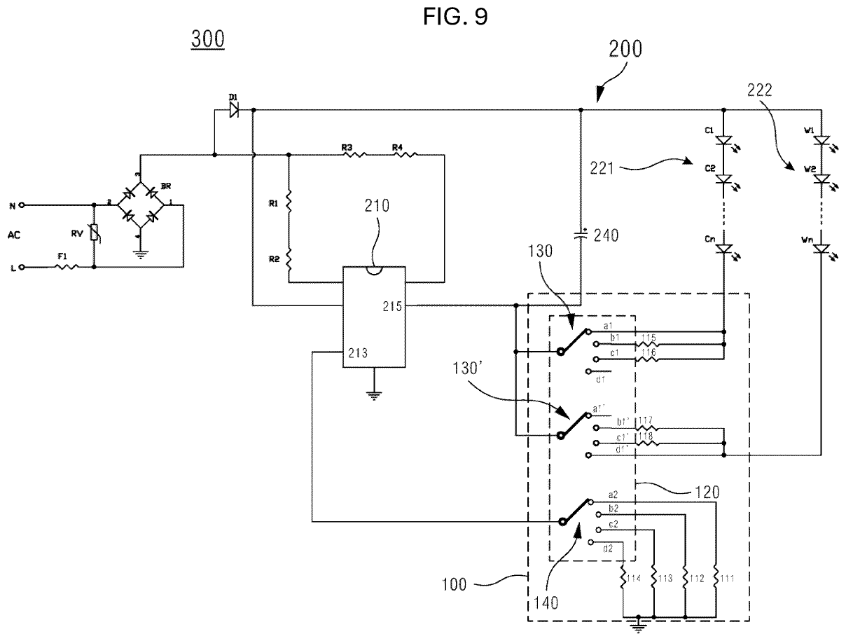

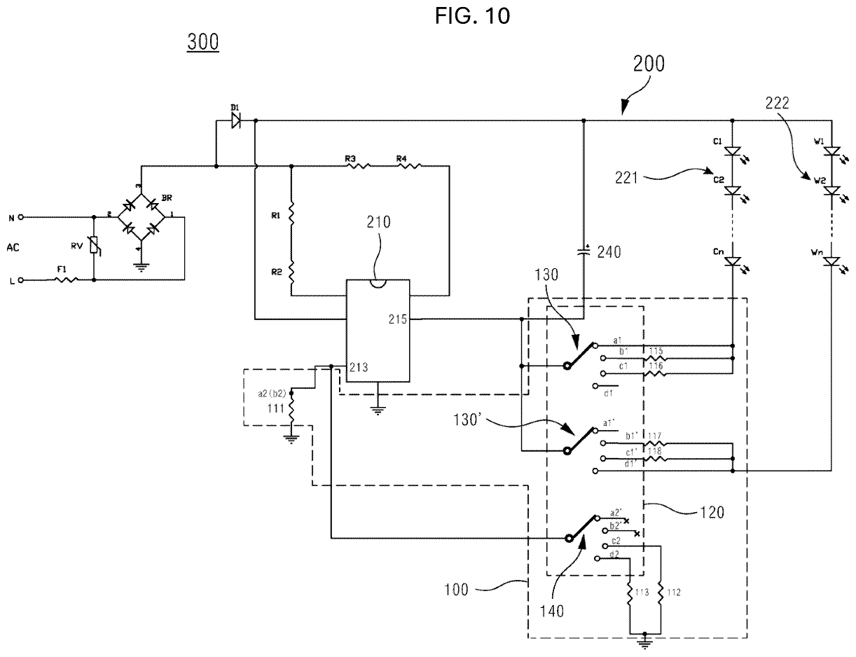

In addition, FIGS. 7 and 8 both show the case in which the selector switch 120 comprises one first switching element 130 and one second switching element 140. In the third embodiment, the selector switch 120 may also comprise one second switching element 140 and at least two first switching elements 130. FIG. 9 is a schematic diagram of a third example of the control unit for a lighting device and the control circuit comprising the control unit according to the third embodiment of the present application; and FIG. 10 is a schematic diagram of a fourth example of the control unit for a lighting device and the control circuit comprising the control unit according to the third embodiment of the present application. The control unit 100 and the control circuit 300 in FIG. 9 are similar to those shown in FIG. 7, and the control unit 100 and the control circuit 300 in FIG. 10 are similar to those shown in FIG. 8, and the differences lie in that: the selector switch 120 in FIG. 9 and FIG. 10 comprises two first switching elements 130 and 130′, and the first lamp load 221 is connected to four first stationary contacts a1, b1, c1 and d1 respectively via four first paths having different resistance values, and the second lamp load 222 is connected to four first stationary contacts a1′, b1′, c1′, and d1′ respectively via four other first paths having different resistance values. Color temperature adjustment for the lighting device by the control unit 100 and the control circuit 300 shown in FIG. 9 and FIG. 10 is similar to that described with reference to FIG. 3, and power adjustment for the lighting device is similar to that described with reference to FIG. 7 and FIG. 8, and therefore they will not be repeated herein.

Further, in an exemplary embodiment, the constant-current driver chip 210 can further comprise a voltage detection terminal 211. The voltage detection terminal 211 may be grounded via a grounding resistor inside the constant-current driver chip 210.

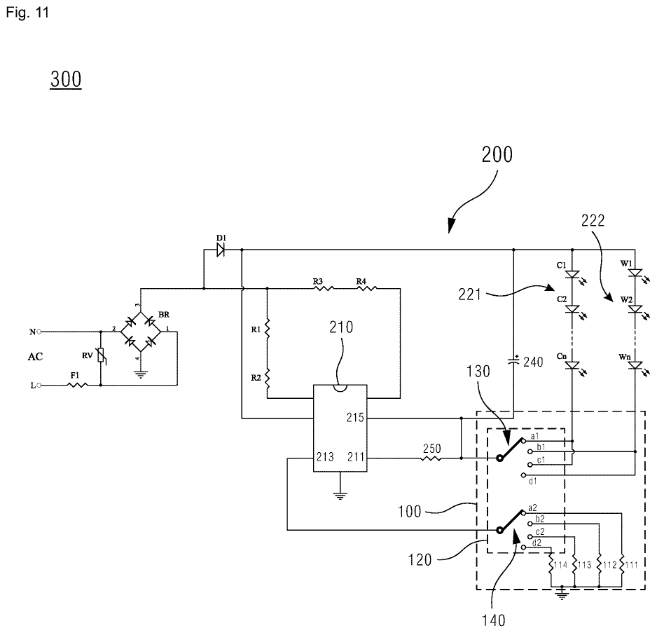

FIG. 11 is a schematic diagram of a fifth example of the control unit for a lighting device and the control circuit comprising the control unit according to the third embodiment of the present application. In the fifth example shown in FIG. 11, the constant-current driver chip 210 comprises a voltage detection terminal 211. The control unit 100 in FIG. 11 is the same as the control unit 100 in FIG. 7. The only difference lies in that: compared to the drive circuit 200 shown in FIG. 7, in the drive circuit 200 of the control circuit 300 shown in FIG. 11, the voltage detection terminal 211 is connected to the current input terminal 215 via a second external resistor 250.

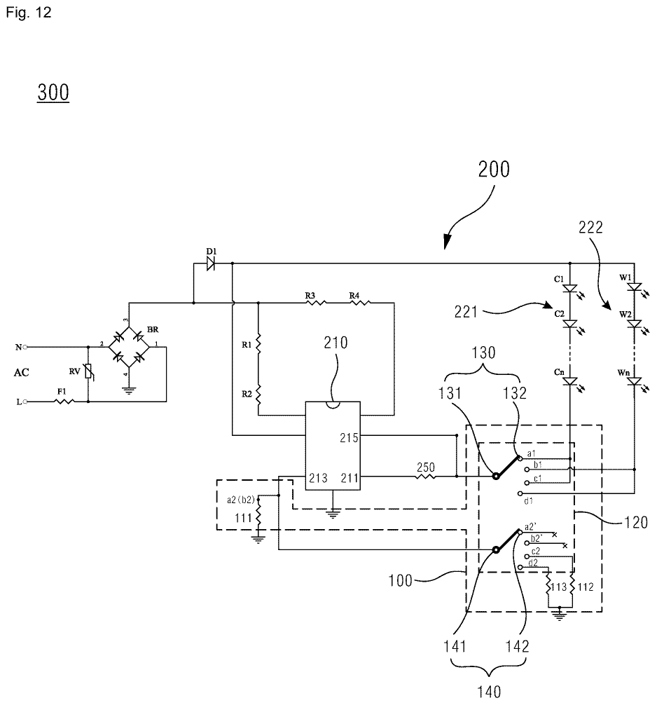

FIG. 12 is a schematic diagram of a sixth example of the control unit for a lighting device and the control circuit comprising the control unit according to the third embodiment of the present application. In the sixth example shown in FIG. 12, the constant-current driver chip 210 comprises a voltage detection terminal 211. The control unit 100 in FIG. 12 is the same as the control unit 100 in FIG. 8. The only difference lies in that: compared to the drive circuit 200 shown in FIG. 8, in the drive circuit 200 of the control circuit 300 shown in FIG. 12, the voltage detection terminal 211 is connected to the current input terminal 215 via a second external resistor 250.

Thus, regardless of whether the constant-current driver chip 210 comprises the voltage detection terminal 211, the power of the lighting device may be adjusted by adjusting the magnitude of the resistance value between the current detection terminal 213 and the ground.

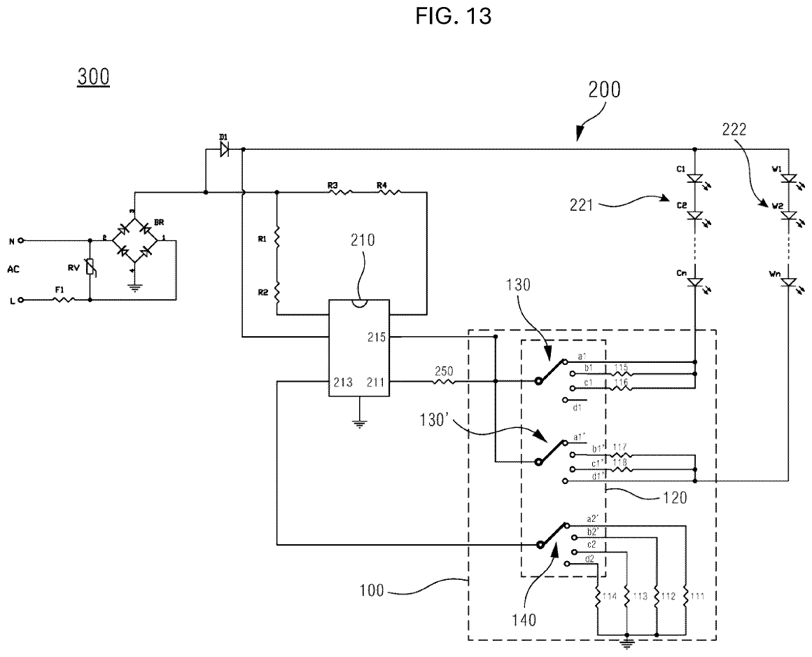

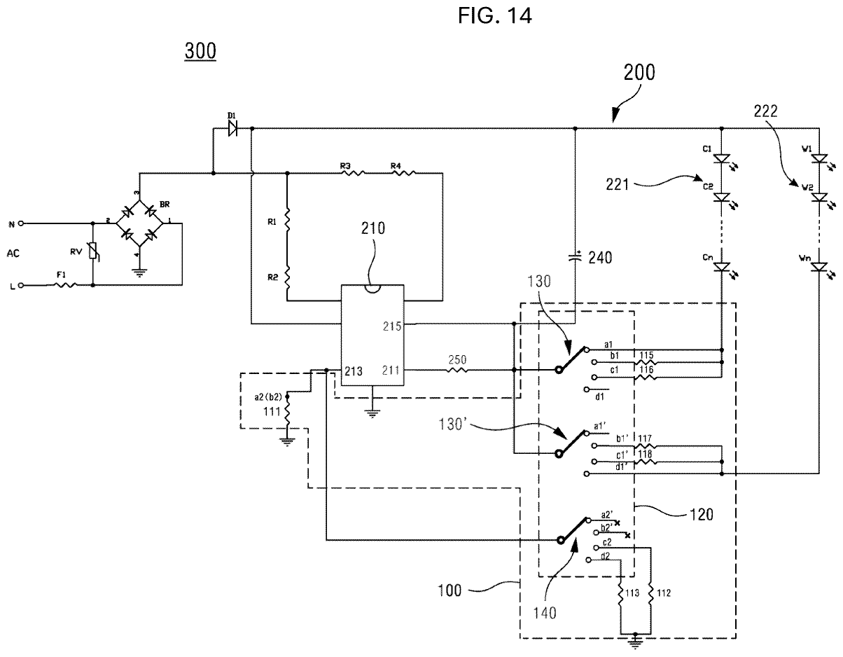

In addition, FIGS. 11 and 12 both show the case in which the selector switch 120 comprises one first switching element 130 and one second switching element 140. In an example in which the constant-current driver chip 210 comprises the voltage detection terminal 211 in the third embodiment, the selector switch 120 may also comprise one second switching element 140 and at least two first switching elements 130. FIG. 13 is a schematic diagram of a seventh example of the control unit for a lighting device and the control circuit comprising the control unit according to the third embodiment of the present application; and FIG. 14 is a schematic diagram of an eighth example of the control unit for a lighting device and the control circuit comprising the control unit according to the third embodiment of the present application. The control unit 100 and the control circuit 300 in FIG. 13 are similar to those shown in FIG. 11, and the control unit 100 and the control circuit 300 in FIG. 14 are similar to those shown in FIG. 12, and the differences lie in that: the selector switch 120 in FIG. 13 and FIG. 14 comprises two first switching elements 130 and 130′, and the first lamp load 221 is connected to four first stationary contacts a1, b1, c1 and d1 respectively via four first paths having different resistance values, and the second lamp load 222 is connected to four first stationary contacts a1′, b1′, c1′, and d1′ respectively via four other first paths having different resistance values. Color temperature adjustment for the lighting device by the control unit 100 and the control circuit 300 shown in FIGS. 13 and 14 is similar to that described with reference to FIG. 3, and will not be repeated herein.

It should be noted that in the third embodiment of the present application, the selector switch 120 (comprising the structures of the first switching element 130 and the second switching element 140 and the arrangements of the first stationary contacts and the second stationary contacts, and the floating terminal may be considered as a part of the plurality of second stationary contacts) may employ the selector switch 120 described with reference to the first embodiment and the second embodiment. Therefore, details of the selector switch 120 in the third embodiment will not be repeated herein.

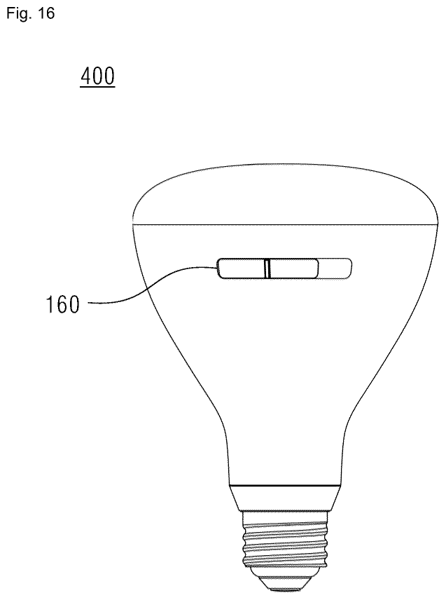

In addition, the present application further provides a lighting device 400. FIG. 16 is a schematic diagram of appearance of a lighting device according to exemplary embodiments of the present application. As shown in FIG. 16, the lighting device 400 comprises the control circuit 300 for a lighting device according to any of the first to third embodiments of the present application as described above, and a bulb housing. The bulb housing encloses the control circuit 300. A selector switch 120 of the control circuit 300 comprises a single manipulation portion 150 which can be manually operated, and the top end of the single manipulation portion 150 is sleeved with an end cap 160, and the end cap 160 is provided on the bulb housing. The manipulation portion 150 is mechanically connected to at least one first movable connection end 132 and a second movable connection end 142 of the selector switch 120, such that when a user manually slides the end cap 160 to operate the manipulation portion 150, the selector switch 120 can connect a current input terminal 215 to a second end of at least one lamp load of a plurality of lamp loads, and at the same time, the current input terminal 215, a voltage detection terminal 211, or a current detection terminal 213 is connected to a second end of any one switching resistor of a plurality of switching resistors.

The manipulation portion 150 may comprise any one of a toggle lever, a slide lever, a button, or a knob. Accordingly, the selector switch 120 may be implemented as a toggle switch, a slide switch, a push switch or a rotary switch. In an exemplary embodiment, the selector switch 120 is a double-pole multi-throw switch or a triple-pole multi-throw switch.

Further, in an exemplary embodiment, the lighting device 400 is a bulb. Thus, the user can conveniently and easily adjust the color temperature and/or power of the lighting device 400 by operating the end cap 160 of the single manipulation portion 150 on the bulb housing of the bulb. Furthermore, by only providing the end cap of the single manipulation portion rather than end caps of two separate manipulation portions on the bulb housing, the structural design of the lighting device can be simplified, the cost of the lighting device can be reduced, and the aesthetics of the lighting device can also be improved.

The lighting device 400 provided in the present application can achieve the same technical effects as those of the control unit 100 and the control circuit 300 described above with reference to FIGS. 1-15, and thus they will not be repeated herein.

It should be noted that the terms used herein are for the purpose of describing specific embodiments only and are not intended to limit exemplary embodiments according to the present application. As used herein, the singular form is intended to comprise the plural form as well, unless the context clearly indicates otherwise, and further it should be understood that the terms “comprises” and/or “comprising” when used in the present description, specify the presence of features, steps, operations, devices, assemblies and/or combinations thereof.

It should be noted that the terms “first”, “second” etc., in the description, claims, and accompanying drawings of the present application are used to distinguish similar objects, and are not necessarily used to describe a specific sequence or order. It should be understood that the data so used may be interchanged where appropriate, so that the embodiments of the present disclosure described herein can be implemented in sequences other than those illustrated or described herein.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

1. A control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is grounded via a grounding resistor inside the constant-current driver chip; and the control unit comprises:
a plurality of switching resistors, wherein each of the switching resistors comprises a first end and a second end, the first end of each of the switching resistors is connected to the voltage detection terminal, and resistance values of at least two switching resistors of the plurality of switching resistors are different from each other; and
a selector switch, which is operable to connect the current input terminal to the second end of at least one lamp load of the plurality of lamp loads, while connecting the current input terminal to the second end of any one switching resistor of the plurality of switching resistors;
wherein the constant-current driver chip is configured to compare a detected first voltage at the current detection terminal with a threshold voltage to control a current flowing through the current input terminal, the threshold voltage being determined according to a detected second voltage at the voltage detection terminal.

2. The control unit for a lighting device according to claim 1, wherein the plurality of switching resistors comprise a first switching resistor, the second end of the first switching resistor being connected to the current input terminal.

3. The control unit for a lighting device according to claim 1, wherein
the selector switch comprises a manipulation portion, at least one first switching element and one second switching element,
wherein each first switching element of the at least one first switching element comprises a first fixed connection end and a first movable connection end, and the second switching element comprises a second fixed connection end and a second movable connection end; the second fixed connection end and the at least one first fixed connection end of the at least one first switching element are connected to the current input terminal, and the second movable connection end and the at least one first movable connection end of the at least one first switching element are both mechanically connected to the manipulation portion.

4. The control unit for a lighting device according to claim 3, wherein the selector switch comprises one first switching element, and the selector switch is operable to connect the current input terminal to the second end of any one lamp load of the plurality of lamp loads, while connecting the current input terminal to the second end of any one switching resistor of the plurality of switching resistors;
the selector switch further comprises a plurality of first stationary contacts and a plurality of second stationary contacts,
the second end of each of the plurality of lamp loads is connected to at least one first stationary contact of the plurality of first stationary contacts via at least one independent first path,
the second end of each of the plurality of switching resistors is connected to at least one second stationary contact of the plurality of second stationary contacts via at least one independent second path; and
the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor.

5. The control unit for a lighting device according to claim 4, wherein the first fixed connection end of the first switching element and the second fixed connection end of the second switching element are configured to be immovable, and the first movable connection end and the second movable connection end are configured to rotate together; and
the plurality of first stationary contacts are arranged around the first fixed connection end at predetermined intervals, and the plurality of second stationary contacts are arranged around the second fixed connection end at the predetermined intervals, such that when the first movable connection end and the second movable connection end move together by the predetermined interval, the first movable connection end switches from being connected to one first stationary contact to being connected to another adjacent first stationary contact, and the second movable connection end switches from being connected to one second stationary contact to being connected to another adjacent second stationary contact.

6. The control unit for a lighting device according to claim 3, wherein the selector switch comprises at least two first switching elements, and the selector switch is operable to connect the current input terminal to the second ends of any two lamp loads of the plurality of lamp loads, while connecting the current input terminal to the second end of any one switching resistor of the plurality of switching resistors;
the selector switch further comprises a plurality of first stationary contacts and a plurality of second stationary contacts,
the second end of each of the at least two lamp loads is connected to at least two first stationary contacts of the plurality of first stationary contacts via at least two independent first paths, and resistance values of the at least two independent first paths are different from each other or partially different from each other;
the second end of each of the plurality of switching resistors is connected to at least one second stationary contact of the plurality of second stationary contacts via at least one independent second path; and
the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor.

7. The control unit for a lighting device according to claim 6, wherein the at least two first fixed connection ends of the at least two first switching elements and the second fixed connection end of the second switching element are configured to be immovable, and the second movable connection end and the at least two first movable connection ends are configured to rotate together;
the at least two first stationary contacts to which the second end of each lamp load of the at least two lamp loads is connected are arranged around a corresponding first fixed connection end of the at least two first fixed connection ends at predetermined intervals, and the plurality of second stationary contacts are arranged around the second fixed connection end at the predetermined intervals, such that when the second movable connection end and the at least two first movable connection ends move together by the predetermined interval, each first movable connection end of the at least two first movable connection ends is switched from being connected to one first stationary contact of the corresponding at least two first stationary contacts to being connected to another adjacent first stationary contact of the corresponding at least two first stationary contacts, and the second movable connection end is switched from being connected to one second stationary contact to being connected to another adjacent second stationary contact.

8. A control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a voltage detection terminal, a current detection terminal and a current input terminal; wherein the current detection terminal is grounded via a first external resistor, the current detection terminal and the current input terminal are connected inside the constant-current driver chip, and the voltage detection terminal is connected to the current input terminal (215) via a second external resistor and is grounded via a grounding resistor inside the constant-current driver chip; and the control unit comprises:
a plurality of switching resistors, wherein each of the switching resistors comprises a first end and a second end, the first end of each of the switching resistors is grounded, and resistance values of at least two switching resistors of the plurality of switching resistors are different from each other;
a floating terminal without electrical connection; and
a selector switch, which is operable to connect the current input terminal to the second end of at least one lamp load of the plurality of lamp loads, while connecting the voltage detection terminal to the second end of any one switching resistor of the plurality of switching resistors or to the floating terminal;
wherein the constant-current driver chip is configured to compare a detected first voltage at the current detection terminal with a threshold voltage to control a current flowing through the current input terminal, the threshold voltage being determined according to a detected second voltage at the voltage detection terminal.

9. The control unit for a lighting device according to claim 8, wherein the selector switch comprises a manipulation portion, at least one first switching element and one second switching element,
wherein each first switching element of the at least one first switching element comprises a first fixed connection end and a first movable connection end, and the second switching element comprises a second fixed connection end and a second movable connection end;
wherein the at least one first fixed connection end of the at least one first switching element is connected to the current input terminal, and the second fixed connection end is connected to the voltage detection terminal, and the second movable connection end and the at least one first movable connection end of the at least one first switching element are both mechanically connected to the manipulation portion.

10. The control unit for a lighting device according to claim 9, wherein the selector switch comprises one first switching element, and the selector switch is operable to connect the current input terminal to the second end of any one lamp load of the plurality of lamp loads, while connecting the voltage detection terminal to the second end of any one switching resistor of the plurality of switching resistors or to the floating terminal;
the selector switch further comprises a plurality of first stationary contacts and a plurality of second stationary contacts,
the second end of each of the plurality of lamp loads is connected to at least one first stationary contact of the plurality of first stationary contacts via at least one independent first path,
the second end of each of the plurality of switching resistors is connected to at least one second stationary contact of the plurality of second stationary contacts via at least one independent second path, and
the floating terminal serves as an additional second stationary contact of the plurality of second stationary contacts, and
the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor or to the second stationary contact which is the floating terminal.

11. The control unit for a lighting device according to claim 10, wherein the first fixed connection end of the first switching element and the second fixed connection end of the second switching element are configured to be immovable, and the first movable connection end and the second movable connection end are configured to rotate together; and
the plurality of first stationary contacts are arranged around the first fixed connection end at predetermined intervals, and the plurality of second stationary contacts and the floating terminal are arranged around the second fixed connection end at the predetermined intervals, such that when the first movable connection end and the second movable connection end move together by the predetermined interval, the first movable connection end switches from being connected to one first stationary contact to being connected to another adjacent first stationary contact, and the second movable connection end switches from being connected to one second stationary contact to being connected to another adjacent second stationary contact.

12. The control unit for a lighting device according to claim 9, wherein the selector switch comprises at least two first switching elements, and the selector switch is operable to connect the current input terminal to the second ends of any two lamp loads of the plurality of lamp loads, while connecting the current input terminal to the second end of any one switching resistor of the plurality of switching resistors;
the selector switch further comprises a plurality of first stationary contacts and a plurality of second stationary contacts,
the second end of each of the at least two lamp loads is connected to at least two first stationary contacts of the plurality of first stationary contacts via at least two independent first paths, and resistance values of the at least two independent first paths are different from each other or partially different from each other;
the second end of each of the plurality of switching resistors is connected to at least one second stationary contact of the plurality of second stationary contacts via at least one independent second path;
the floating terminal serves as an additional second stationary contact of the plurality of second stationary contacts; and
the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor, or to the second stationary contact which is the floating terminal.

13. The control unit for a lighting device according to claim 12, wherein the at least two first fixed connection ends of the at least two first switching elements and the second fixed connection end of the second switching element are configured to be immovable, and the second movable connection end and the at least two first movable connection ends are configured to rotate together; and
the at least two first stationary contacts to which the second end of each lamp load of the at least two lamp loads is connected are arranged around a corresponding first fixed connection end of the at least two first fixed connection ends at predetermined intervals, and the plurality of second stationary contacts are arranged around the second fixed connection end at the predetermined intervals, such that when the second movable connection end and the at least two first movable connection ends move together by the predetermined interval, each first movable connection end of the at least two first movable connection ends is switched from being connected to one first stationary contact of the corresponding at least two first stationary contacts to being connected to another adjacent first stationary contact of the corresponding at least two first stationary contacts, and the second movable connection end is switched from being connected to one second stationary contact to being connected to another adjacent second stationary contact.

14. A control unit for a lighting device, the lighting device comprising a drive circuit and a plurality of lamp loads, wherein color temperatures of at least two lamp loads of the plurality of lamp loads are different from each other, each of the lamp loads comprises a first end and a second end, and the first end of each of the lamp loads is connected to a power input end, and the control unit is connected to the drive circuit; the drive circuit comprises a constant-current driver chip, the constant-current driver chip comprising a current detection terminal and a current input terminal, wherein the current detection terminal and the current input terminal are connected inside the constant-current driver chip; and the control unit comprises:
a plurality of switching resistors, wherein each of the switching resistors comprises a first end and a second end, the first end of each of the switching resistors is grounded, and resistance values of at least two switching resistors of the plurality of switching resistors are different from each other; and
a selector switch, which is operable to connect the current input terminal to the second end of at least one lamp load of the plurality of lamp loads, while connecting the current detection terminal to the second end of any one switching resistor of the plurality of switching resistors;
wherein the constant-current driver chip is configured to compare a detected first voltage at the current detection terminal with a fixed threshold voltage to control a current flowing through the current input terminal.

15. The control unit for a lighting device according to claim 14, wherein the plurality of switching resistors comprise a first switching resistor, the second end of the first switching resistor being connected to the current detection terminal.

16. The control unit for a lighting device according to claim 14, wherein the constant-current driver chip further comprises a voltage detection terminal, the voltage detection terminal being grounded via a grounding resistor inside the constant-current driver chip.

17. The control unit for a lighting device according to claim 14, wherein the selector switch comprises a manipulation portion, at least one first switching element and one second switching element,
wherein each first switching element of the at least one first switching element comprises a first fixed connection end and a first movable connection end, and the second switching element comprises a second fixed connection end and a second movable connection end;
wherein the at least one first fixed connection end of the at least one first switching element is connected to the current input terminal, and the second fixed connection end is connected to the current detection terminal, and the second movable connection end and the at least one first movable connection end of the at least one first switching element are both mechanically connected to the manipulation portion.

18. The control unit for a lighting device according to claim 17, wherein the selector switch comprises one first switching element, and the selector switch is operable to connect the current input terminal to the second end of any one lamp load of the plurality of lamp loads, while connecting the current detection terminal to the second end of any one switching resistor of the plurality of switching resistors;
the selector switch further comprises a plurality of first stationary contacts and a plurality of second stationary contacts,
the second end of each of the plurality of lamp loads is connected to at least one first stationary contact of the plurality of first stationary contacts via at least one independent first path,
the second end of each of the plurality of switching resistors is connected to at least one second stationary contact of the plurality of second stationary contacts via at least one independent second path, and
the manipulation portion is operable, such that the first movable connection end of the first switching element is connected to any of the first stationary contacts connected to the second end of the any one lamp load, and at the same time, the second movable connection end of the second switching element is connected to any of the second stationary contacts connected to the second end of the any one switching resistor.

19. The control unit for a lighting device according to claim 17, wherein the selector switch comprises at least two first switching elements, and the selector switch is operable to connect the current input terminal to the second ends of any two lamp loads of the plurality of lamp loads, while connecting the current detection terminal to the second end of any one switching resistor of the plurality of switching resistors; and
the selector switch further comprises a plurality of first stationary contacts and a plurality of second stationary contacts,
the second end of each of the at least two lamp loads is connected to at least two first stationary contacts of the plurality of first stationary contacts via at least two independent first paths, and resistance values of the at least two independent first paths are different from each other or partially different from each other;
the second end of each of the plurality of switching resistors is connected to at least one second stationary contact of the plurality of second stationary contacts via at least one independent second path; and
the manipulation portion is operable, such that each first movable connection end of the at least two first movable connection ends of the at least two first switching elements is connected to any of the first stationary contacts connected to the second end of a corresponding lamp load of the at least two lamp loads, and at the same time, the second movable connection end of the second switching element is connected to any of the second stationary contacts connected to the second end of the any one switching resistor.

20. A control circuit for a lighting device, the control circuit comprising:
the control unit for a lighting device according to claim 1; and
a drive circuit for the lighting device, the drive circuit being connected to the control unit, wherein the drive circuit comprises a constant-current driver chip, the constant-current driver chip comprising a voltage detection terminal, a current detection terminal and a current input terminal, wherein the current detection terminal is grounded via a first external resistor, the current detection terminal and the current input terminal are connected inside the constant-current driver chip, and the voltage detection terminal is grounded via a grounding resistor inside the constant-current driver chip;
wherein the constant-current driver chip is configured to compare a detected first voltage at the current detection terminal with a threshold voltage to control a current flowing through the current input terminal, the threshold voltage being determined according to a detected second voltage at the voltage detection terminal.

21. A control circuit for a lighting device, the control circuit comprising:
the control unit for a lighting device according to claims 8; and
a drive circuit for the lighting device, the drive circuit being connected to the control unit, the drive circuit comprises a constant-current driver chip, the constant-current driver chip comprising a voltage detection terminal, a current detection terminal and a current input terminal; wherein the current detection terminal is grounded via a first external resistor, the current detection terminal and the current input terminal are connected inside the constant-current driver chip, and the voltage detection terminal is connected to the current input terminal via a second external resistor and is grounded via a grounding resistor inside the constant-current driver chip;
wherein the constant-current driver chip is configured to compare a detected first voltage at the current detection terminal with a threshold voltage to control a current flowing through the current input terminal, the threshold voltage being determined according to a detected second voltage at the voltage detection terminal.

22. A control circuit for a lighting device, the control circuit comprising:
the control unit for a lighting device according to claim 14; and
a drive circuit for the lighting device, the drive circuit being connected to the control unit, wherein the drive circuit comprises a constant-current driver chip, the constant-current driver chip comprising a current detection terminal and a current input terminal, wherein the current detection terminal and the current input terminal are connected inside the constant-current driver chip,
wherein the constant-current driver chip is configured to compare a detected first voltage at the current detection terminal with a fixed threshold voltage to control a current flowing through the current input terminal.

23. A lighting device, the lighting device comprising:
the control circuit for a lighting device according to claim 20; and
a bulb housing, enclosing the control circuit;
wherein a selector switch of the control circuit comprises a single manipulation portion which can be manually operated, and the manipulation portion is arranged on the bulb housing.

24. The lighting device according to claim 23, wherein the manipulation portion comprises any one of: a toggle lever, a slide lever, a button or a knob.
